(19) United States
(12) Patent Application Publication
(10) Pub. No.: US 2015/0132690 A1
(43) Pub. Date: May 14, 2015

(54) TONER, DEVELOPER AND IMAGE FORMING APPARATUS USING THE SAME

(71) Applicants: Daisuke ASAHINA, Shizuoka (JP); Azumi MIYAAKE, Kanagawa (JP); Tsuyoshi SUGIMOTO, Shizuoka (JP); Susumu CHIBA, Shizuoka (JP); Shinya NAKAYAMA, Shizuoka (JP); Hiroshi YAMASHITA, Shizuoka (JP); Satoyuki SEKIGUCHI, Shizuoka (JP)

(72) Inventors: Daisuke ASAHINA, Shizuoka (JP); Azumi MIYAAKE, Kanagawa (JP); Tsuyoshi SUGIMOTO, Shizuoka (JP); Susumu CHIBA, Shizuoka (JP); Shinya NAKAYAMA, Shizuoka (JP); Hiroshi YAMASHITA, Shizuoka (JP); Satoyuki SEKIGUCHI, Shizuoka (JP)

(21) Appl. No.: 14/534,495

(22) Filed: Nov. 6, 2014

(30) Foreign Application Priority Data
Nov. 8, 2013 (JP) 2013-231784

(51) Int. Cl. G03G 9/00

(52) U.S. Cl. CPC G03G 9/08755; G03G 9/0821
USPC 430/105; 430/109.4

(57) ABSTRACT

A toner includes a binder resin including a copolymer resin (A) having a structural unit derived from a crystalline polyester resin (A1) and another structural unit derived from an amorphous polyester resin (A2), and an amorphous resin (B) in an amount of from 30 to 70% by weight based on total weight of the binder resin. The binarized image of the AFM phase image of the binder resin consists of first phase-contrast images serving as large-phase-difference portions and second phase-contrast images serving as small-phase-difference portions with the first phase-contrast images dispersed in the second phase-contrast images forming a dot-like or streaky structure. The average value of dispersion diameters, corresponding to maximum Feret diameters, of the first phase-contrast images in the dot-like structure, or widths, corresponding to minimum Feret diameters, of the first phase-contrast images in the streaky structure, is less than 100 nm.

### CROSS-REFERENCE TO RELATED APPLICATIONS

This patent application is based on and claims priority pursuant to 35 U.S.C. §119(a) to Japanese Patent Application No. 2013-231784, filed on Nov. 8, 2013, in the Japan Patent Office, the entire disclosure of which is hereby incorporated by reference herein.

### BACKGROUND

1. Technical Field

The present disclosure relates to a toner, and a developer and an image forming apparatus using the toner.

2. Description of the Related Art

In a typical electrophotographic image forming apparatus, an electrically- or magnetically-formed latent image is visualized with toner. Specifically, in electrophotography, an electrostatic latent image is formed on a photoreceptor and then developed into a toner image with toner. The toner image is transferred onto a transfer medium such as paper and then fixed thereon. In fixing the toner image on a transfer medium, heat fixing methods such as heat roller fixing method and heat belt fixing method are widely employed because of their high energy efficiency.

In recent years, demand for high-speed-printing and energy-saving image forming apparatus is increasing. In accordance with this demand, toner is required to be fixable at much lower temperatures while providing much higher image quality. One approach for achieving low-temperature fixability of toner involves reducing the softening temperature of the binder resin of toner. However, such a low softening temperature of the binder resin is likely to cause offset phenomenon in which a part of toner image is adhered to a surface of a fixing member and then retransferred onto a transfer medium in the fixing process. Reducing the softening temperature of the binder resin also reduces heat-resistant storage stability of toner. As a result, blocking phenomenon in which toner particles fuse together is caused especially in high-temperature environments. In addition, other problems are likely to occur such that toner fuses to contaminate developing device or carrier particles, or toner forms its film on a surface of photoreceptor.

As a technique for solving these problems, using crystalline resin for the binder resin of toner is known. Crystalline resin has a property of rapidly softening at the melting point. This property makes it possible to lower fixable temperature of toner without degrading its heat-resistant storage stability at or below the melting point. Namely, it is possible to achieve an excellent balance of low-temperature fixability and heat-resistant storage stability at the same time. Although having high toughness, while at the same time, crystalline resin having a melting point which exhibits low-temperature fixability is plastic deformable due to its softness. The technique of merely using a crystalline resin for the binder resin results in a toner having poor mechanical durability, which causes various problems such as deformation, aggregation, and sticking within image forming apparatus and contamination of image forming members.

In view of this situation, a number of toners using both a crystalline resin and an amorphous resin have been proposed. Such toners are generally superior to those using only an amorphous resin in terms of the balance between low-temperature fixability and heat-resistant storage stability. However, if the crystalline resin is exposed at the surface of toner, toner particles may aggregate under agitation stress in developing device to cause transfer deficiency, or may contaminate carrier particles and the inside of apparatus. In addition, external additive may be embedded in the surface of toner to degrade chargeability and fluidity of toner. Accordingly, the addition amount of crystalline resin should be limited such that it has been difficult to take advantage of having crystalline resin.

In addition, a number of toners have been proposed which use a resin in which crystalline segments and amorphous segments are chemically bonded.

Such toners can achieve a good balance between low-temperature fixability and heat-resistant storage stability but their softness arising from the crystalline segment has not basically improved. The problem regarding mechanical durability of toner is not solved by these toners.

A toner using a crystalline resin has another problem of rub resistance of the resulting image. When the toner is once melted by heat to be fixed on a transfer medium, it will take a certain time until the crystalline resin recrystallizes and the surface of the image cannot promptly recover its hardness. As a result, the surface of the image may be scratched upon contact with discharge roller or conveyance members in the paper discharge process after the image fixing process, reducing the gloss of the image.

### SUMMARY

In accordance with some embodiments, a toner including a colorant, a release agent, and a binder resin is provided. The binder resin includes a copolymer resin (A) having a structural unit derived from a crystalline polyester resin (A1) and another structural unit derived from an amorphous polyester resin (A2), and an amorphous resin (B) in an amount of from 30 to 70% by weight based on total weight of the binder resin. When the binder resin is observed with an atomic force microscope in tapping mode to obtain a phase image and the phase image is binarized by using an intermediate value between maximum and minimum phase difference values to obtain a binarized image, the binarized image consists of first phase-contrast images serving as large-phase-difference portions and second phase-contrast images serving as small-phase-difference portions with the first phase-contrast images dispersed in the second phase-contrast images forming a dot-like or streaky structure. The average value of dispersion diameters, corresponding to maximum Feret diameters, of the first phase-contrast images in the dot-like structure, or widths, corresponding to minimum Feret diameters, of the first phase-contrast images in the streaky structure, is less than 100 nm when determined by the following procedures (I) to (III):

(I) subject ten randomly-selected 300-nm-square phase images of the binder resin to the binarization processing;

(II) measure the maximum Feret diameters of the first phase-contrast images in the dot-like structure or the minimum Feret diameters of the first phase-contrast images in the streaky structure in each of the ten binarized images; and

(III) average the top 30 maximum Feret diameters of the first phase-contrast images in the dot-like structure or the top 30 minimum Feret diameters of the first phase-contrast images in the streaky structure.

In accordance with some embodiments, a developer is provided. The developer includes the above-described toner and a carrier.

In accordance with some embodiments, an image forming apparatus is provided. The image forming apparatus includes an electrostatic latent image bearing member, an electrostatic latent image forming device to form an electrostatic latent image on the electrostatic latent image bearing member, a developing device to develop the electrostatic latent image into a visible image with the above-described toner, a transfer device to transfer the visible image onto a recording medium, and a fixing device to fix the visible image on the recording medium.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an example of a phase image of the binder resin obtained with AFM in tapping mode;

FIG. 2 is an example of a binarized image of a phase image of the binder resin obtained with AFM in tapping mode;

FIG. 3 is an example of a phase image obtained with AFM in tapping mode which is not used for the calculation of average dispersion diameter;

FIG. 4 is an example of a phase image of the binder resin obtained with AFM in tapping mode, having a streaky structure;

FIG. 5 is a schematic view of an image forming apparatus according to an embodiment of the invention;

FIG. 6 is a schematic view of an image forming apparatus according to an embodiment of the invention;

FIG. 7 is a schematic view of a tandem-type full-color image forming apparatus according to an embodiment of the invention; and

FIG. 8 is a partial magnified view of FIG. 7.

### DETAILED DESCRIPTION

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

For the sake of simplicity, the same reference number will be given to identical constituent elements such as parts and materials having the same functions and redundant descriptions thereof omitted unless otherwise stated.

One object of the present invention is to provide a toner which: (1) has sharply-melting property for achieving an excellent balance between low-temperature fixability and heat-resistant storage stability; (2) avoids the problems specific to toner including crystalline resin, such as toner aggregation in developing device or toner contamination of carrier particles or the inside of apparatus caused by poor mechanical durability of the toner, and deterioration in chargeability and fluidity caused by embedment of external additives to the surface of the toner; and (3) provides high-quality image with high rub resistance by rapidly recovering its elastic modulus after being fixed on recording medium to improve the hardness of the fixed image.

According to some embodiments of the present invention, a toner is provided which: (1) has sharply-melting property for achieving an excellent balance between low-temperature fixability and heat-resistant storage stability; (2) avoids the problems specific to toner including crystalline resin, such as toner aggregation in developing device or toner contamination of carrier particles or the inside of apparatus caused by poor mechanical durability of the toner, and deterioration in chargeability and fluidity caused by embedment of external additives to the surface of the toner; and (3) provides high-quality image with high rub resistance by rapidly recovering its elastic modulus after being fixed on recording medium to improve the hardness of the fixed image.

To solve the above-described problems, the inventors of the present invention have discovered a technique which chemically binds a crystalline segment and an amorphous segment together and restrains the molecular motion of the crystalline segment by controlling the structure of each segment. According to this technique, the toner can maintain a certain level of sharply-melting property for achieving an excellent balance between low-temperature fixability and heat-resistant storage stability while the occurrence of toner aggregation in developing device is prevented and the problem of transfer deficiency is solved. The toner particles are prevented from contaminating carrier particles and the inside of apparatus. In addition, external additive is prevented from being embedded in the surface of the toner to prevent deterioration of chargeability and fluidity of the toner. Moreover, the toner rapidly recovers its elastic modulus after being fixed on recording medium to improve the hardness of the fixed image, providing high-quality image with high rub resistance.

The inventors of the present invention assume that the plastic deformable property of crystalline resin is attributable to a folded structure of polymer chains in crystalline segment. The crystalline segment consists of a crystalline region in which molecular chains are orderly folded, a folding back region at which molecular chains are folded back, and an amorphous region consisting of molecular chains existing between the crystalline regions. Even straight-chain polyethylene single crystal, having a high crystallinity, contains about 3% of the amorphous region. High molecular mobility of the amorphous region largely contributes to the plastic deformable property of crystalline resin. Therefore, how to restrain the molecular mobility is important issue for making use of crystalline resin.

According to an embodiment of the invention, a combination of a crystalline segment and an amorphous segment which is capable of restraining the molecular motion of the crystalline segment is selected. They are controlled to form a microphase dispersion structure within the toner. The microphase dispersion structure is a fine sea-island structure with the sea consisting of the amorphous segment and the island consisting of the crystalline segment.

With such a configuration, at or below the melting point of the crystalline segment, the amorphous segment restrains the molecular motion and therefore the toner exhibits excellent mechanical durability. The toner rapidly undergoes elastic relaxation and deformation within fixable temperature range. At the time the paper having the fixed image is discharged, the amorphous segment immediately suppresses excessive molecular motion of the crystalline segment, and at the same time, the fine sea-island structure prevents the crystalline segment from being exposed at the surface of the image with rapid recovery of the hardness of the image.

A suitable combination of the crystalline segment and the amorphous segment gives low-temperature fixability, sufficient strength, lubricating property, and resistance to thermal and mechanical stresses to the toner, while preventing the occurrence of toner blocking, aggregation, and charge leakage. The crystalline polyester resin (A1), amorphous polyester resin (A2), and amorphous resin (B) are not limited in material and have many choices. They can be chosen based on pigment dispersibility, etc.

Accordingly, a toner including a colorant, a release agent, and a binder resin is provided. The binder resin includes a copolymer resin (A) having a structural unit derived from a crystalline polyester resin (A1) and another structural unit derived from an amorphous polyester resin (A2), and an amorphous resin (B) in an amount of from 30 to 70% by weight based on total weight of the binder resin. When the binder resin is observed with an atomic force microscope in tapping mode to obtain a phase image and the phase image is binarized by using an intermediate value between maximum and minimum phase difference values to obtain a binarized image, the binarized image consists of first phase-contrast images serving as large-phase-difference portions and second phase-contrast images serving as small-phase-difference portions with the first phase-contrast images dispersed in the second phase-contrast images forming a dot-like or streaky structure. The average value of dispersion diameters, corresponding to maximum Feret diameters, of the first phase-contrast images in the dot-like structure, or widths, corresponding to minimum Feret diameters, of the first phase-contrast images in the streaky structure, is less than 100 nm when determined by the following procedures (I) to (III):

(I) subject ten randomly-selected 300-nm-square phase images of the binder resin to the binarization processing;

(II) measure the maximum Feret diameters of the first phase-contrast images in the dot-like structure or the minimum Feret diameters of the first phase-contrast images in the streaky structure in each of the ten binarized images; and

(III) average the top 30 maximum Feret diameters of the first phase-contrast images in the dot-like structure or the top 30 minimum Feret diameters of the first phase-contrast images in the streaky structure.

### Toner for Image Formation

The toner according to an embodiment of the invention includes a colorant, a release agent, and a binder resin.

The binder resin includes a copolymer resin (A) having a structural unit derived from a crystalline polyester resin (A1) and another structural unit derived from an amorphous polyester resin (A2), and an amorphous resin (B) in an amount of from 30 to 70% by weight based on total weight of the binder resin.

Preferably, the binder resin includes the amorphous resin (B) in an amount of from 30 to 50% by weight based on total weight of the binder resin.

When the content rate of the amorphous resin (B) in the binder resin is less than 30% by weight, margin of thermal and mechanical durability is so reduced that stability cannot be kept. Although low-temperature fixability is achieved, the storage elastic modulus within the fixable temperature range may excessively decrease to narrow the fixable temperature range with decreasing machine versatility.

When the content rate of the amorphous resin (B) in the binder resin exceeds 70% by weight, thermal and mechanical durability improves but the crystalline resin cannot become less viscous within the fixable temperature range. This means that the trade-off between stability and low-temperature fixability cannot be resolved.

Preferably, the binder resin includes the copolymer resin (A) in an amount of from 30 to 70% by weight, more preferably from 50 to 70% by weight, based on total weight of the binder resin.

When the binder resin includes the copolymer resin (A) in an amount of from 30 to 70% by weight, a good balance can be achieved between resistance to thermal and mechanical stress and low-temperature fixability.

The binder resin may further include another crystalline resin as the third component which has similar properties to the crystalline polyester resin (A1). In this case, the crystalline resin can be contained inside the microphase separation domains of the copolymer resin.

### Block Copolymer Resin

Block copolymer is a polymer in which heterogeneous polymer chains are bound together with covalent bonds. Generally, in most cases, heterogeneous polymer chains are incompatible with each other. They are not to mingle with each other like water and oil. In a simple mixed system, heterogeneous polymer chains are independently movable to cause macrophase separation. In a copolymer, by contrast, heterogeneous polymer chains are connected to each other and cannot cause macrophase separation. Although being connected to each other, heterogeneous polymer chains are likely to separate from each other as far as possible while homogeneous polymer chains become aggregated. As a result, the copolymer has alternating polymer-chain-size units each rich with a component A or a component B, for example. The phase separation structure is variable depending on the degree of phase mixing, composition, length (i.e., molecular weight and distribution), and/or mixing ratio of the components A and B. By controlling these properties, the phase separation structure can be controlled to take a periodic order mesostructure such as the spherical structure, cylindrical structure, gyroidal structure, or lamellar structure as described in A. K. Khandpur, S. Forster, and F. S. Bates, Macromolecules, 28 (1995) 8796-8806.

According to an embodiment of the invention, the binder resin includes a block copolymer resin having a crystalline segment and an amorphous segment. When a block copolymer resin having a microphase separation structure is controlled to recrystallize forming the periodic order mesostructure, crystalline phases with a size of several tens to several hundreds nanometers can be orderly arranged while making the microphase separation structure of the melted body as a template. Taking advantage of such higher order structure, fluidity and deformability is given to toner based on solid-liquid phase transition phenomenon of the crystalline segment, especially in a situation where fluidity is required such as fixing process, and the motion of the crystalline segment is restrained by containing the crystalline segment inside the structure, especially in a situation where neither fluidity nor deformability is required such as storage or conveyance process after the fixing process.

The molecular structure, crystallinity, and higher order structure, such as microphase separation structure, of the copolymer resin (A) can be readily analyzed by known methods. Specifically, these properties can be analyzed by means of high-resolution NMR (1H, 13C, etc.), differential scanning calorimetry (DSC), wide-angle X-ray diffractometry, (pyrolytic) GC/MS, LC/MS, infrared absorption spectroscopy (IR), atomic force microscopy, transmission electron microscopy (TEM), etc.

Whether a toner includes the copolymer resin (A) or not can be determined by the following procedure, for example.

First, dissolve a toner in a solvent such as ethyl acetate and THF, or subject a toner to soxhlet extraction. Subject the resulting solution to centrifugal separation using a high-speed centrifugal separator having cooling function at a temperature of 20° C. and a revolution of 10,000 rpm for 10 minutes to separate soluble components from insoluble components. Subject the soluble components to several times of reprecipitation and then purification. This procedure is capable of separating highly-cross-linked resin components, pigments, and waxes from each other.

Next, subject the isolated resin component to gel permeation chromatography (GPC) to obtain its molecular weight, molecular weight distribution, and chromatogram. When the obtained chromatogram has multiple peaks, fractionate the sample with a fraction collector. Separate and purify each resin component by this operation and then subject them to analytic operations.

First, subject each purified product to differential scanning calorimetry (DSC) to obtain glass transition temperature (Tg), melting point, and crystallization behavior. If a crystallization peak is observed during cooling, subject it to annealing for at least 24 hours within that temperature range so that the crystalline component grows. If crystallization is not observed but a melting peak is observed, subject it to annealing at a temperature 10° C. lower than the melting point. Various transition temperatures and the existence of crystalline skeleton can be confirmed by this procedure.

Next, confirm whether a phase separation structure exists or not by SPM (AFM) and/or TEM observation. Confirmation of the existence of a microphase separation structure indicates that the sample is a copolymer or a system having high intramolecular and/or intermolecular interaction.

Further subject the purified products to the measurements with FT-IR, NMR (1H, 13C, etc), and GC/MS, and optionally NMR (2D) for detailed analysis of molecular structure, to obtain composition, structure, and other various properties, for example, the existence of polyester skeleton or urethane bond and the composition and compositional ratio thereof.

Whether a toner includes the copolymer resin (A) or not can be determined by comprehensive evaluation of the above analyses.

### Example of GPC Measurement

Gel permeation chromatography (GPC) measurement can be made by a gel permeation chromatographic instrument (such as HLC-8220 GPC from Tohsoh Corporation) preferably equipped with a fraction collector.

Triplet of 15-cm column TSKgel Super HZM-H is preferably used. First, prepare a 0.15% tetrahydrofuran (THF, containing a stabilizer, from Wako Pure Chemical Industries, Ltd.) solution of a sample resin. Filter the solution with 0.2-μm filter and use the filtrate as a specimen in succeeding procedures. Inject 100 μl of the specimen into the instrument and subject it to a measurement at 40° C. and a flow rate of 0.35 ml/min.

Determine molecular weight with reference to a calibration curve compiled from monodisperse polystyrene standard samples. As the polystyrene standard samples, Showdex STANDARD series from Showa Denko K.K. and toluene can be used. Prepare three kinds of THF solutions A, B, and C of monodisperse polystyrene standard samples having the following compositions and subject them to the measurement under the above-described conditions. Compile a calibration curve with light-scattering molecular weights of the monodisperse polystyrene standard samples that are represented by retention time for the peaks.

Solution A: 2.5 mg of S-7450, 2.5 mg of S-678, 2.5 mg of S-46.5, 2.5 mg of S-2.90, and 50 ml of THF

Solution B: 2.5 mg of S-3730, 2.5 mg of S-257, 2.5 mg of S-19.8, 2.5 mg of S-0.580, and 50 ml of THF

Solution C: 2.5 mg of S-1470, 2.5 mg of S-112, 2.5 mg of S-6.93, 2.5 mg of toluene, and 50 ml of THF

A refraction index (RI) detector is preferably used as the detector. An ultraviolet (UV) detector that is more sensitive is preferably used when fractionation is conducted.

### Example of DSC Measurement

Contain 5 mg of a sample in a simple sealed pan Tzero (from TA Instruments). Subject it to a measurement with a differential scanning calorimeter (Q2000 from TA Instruments). In the measurement, under nitrogen gas flow, firstly heat the sample from 40° C. to 150° C. at a heating rate of 5° C./min and kept for 5 minutes, and then cool it to −70° C. and kept for 5 minutes. Secondly, heat the sample at a heating rate of 5° C./min to measure thermal change. Draw a graph showing the relation between the quantity of heat absorption or generation and temperature. Determine glass transition temperature (Tg), cold crystallization temperature, melting point, crystallization temperature, etc., in accordance with the known methods. Tg is determined from the DSC curve in the first heating by the midpoint method. It is to be noted that when the heating profile is not linear and includes short repeated cycles of heating and cooling or sine-curve heating (for example, when the heating rate is set to 3° C./min and the modulation period is set to ±0.5° C./min), it is possible to separate enthalpy relaxation components.

### Example of TEM Observation

### Procedures

(1) Expose a sample to atmosphere of RuO₄ aqueous solution for 2 hours to get dyed.
(2) Trim the sample with a glass knife and then cut it into sections with an ultramicrotome under the following cutting conditions.

Cutting Conditions
Cutting thickness: 75 nm
Cutting speed: 0.05 to 0.2 mm/sec
Knife: Diamond knife (Ultra Sonic 35°)
   (3) Fix the section on a mesh and expose it to atmosphere of RuO₄ aqueous solution for 5 minutes to get dyed.

### Observation Conditions

Instrument: Transmission electron microscope JEM-2100F from JEOL Ltd.

Acceleration voltage: 200 kV

Observation: Bright-field method

Settings: Spot size 3, CLAP 1, OLAP 3, Alpha 3

### Example of FT-IR Measurement

Fourier transform infrared spectroscopy (FT-IR) measurement can be made by an FT-IR spectrometer (Spectrum One from PerkinElmer Co., Ltd.). The scan number, resolution capability, and wavelength region are 16, 2 cm⁻¹, and mid-infrared region (400 to 4,000 cm⁻¹), respectively.

### Example of NMR Measurement

Dissolve as much of a sample as possible in deuterated chloroform. Contain the solution in an NMR sample tube having a diameter of 5 mm and subject it to a nuclear magnetic resonance (NMR) measurement. The measurement is made by an instrument JNM-ECX-300 from JEOL RESONANCE Inc.

The measurement temperature is 30° C. In 1H-NMR measurement, the cumulated number is 256 and the repeating time is 5.0 s. In 13C-NMR measurement, the cumulated number is 10,000 and the repeating time is 1.5 s. Identify components from the obtained chemical shift. Determine the compounding ratio from the numeral value obtained by dividing the value of integral for an objective peak by the number of proton or carbon. To conduct more detailed structural analysis, DQF-COSY (Double Quantum Filtered Correlated Spectroscopy) measurement can be made. In this measurement, the cumulated number is 1,000 and the repeating time is 2.45 s or 2.80 s. It is possible to specify coupling condition, i.e., reaction site, from the obtained spectrum.

### Example of GC/MS Measurement

A measurement can be made by a reaction pyrolysis gas chromatography mass spectrometry (GC/MS) using a reaction reagent. As the reaction reagent, a 10% methanol solution of tetramethylammonium hydroxide (TMAH) (from Tokyo Chemical Industry Co., Ltd.) is used. A GC-MS instrument QP2010 (from Shimadzu Corporation), a data analysis software program GCMSsolution (from Shimadzu Corporation), and a heating device Py2020D from Frontier Laboratories Ltd. are used.

### Analysis Conditions

Reaction pyrolysis temperature: 300° C.

Column: Ultra ALLOY-5, L=30 m, ID=0.25 mm, Film=0.25 μm

Column heating: 50° C. (keep 1 minute)˜10° C./min˜330° C. (keep 11 minutes)

Carrier gas pressure: 53.6 KPa (constant)

Column flow rate: 1.0 ml/min

Ionization method: EI method (70 eV)

Mass range: m/z=29˜700

Injection mode: Split (1:100)

Structural Unit derived from Amorphous Polyester Resin (A2) and Amorphous Resin (B)

The amorphous polyester resin (A2) for the copolymer resin (A) is not limited to any particular resin.

The amorphous resin (B) is not limited to any particular resin. However, preferably, the amorphous resin (B) is an amorphous polyester resin because of its high affinity for paper, which is the main recording medium (transfer medium), and high heat-resistant storage stability.

The hydroxyl value of each of the amorphous polyester resin (A2) and the amorphous resin (B) is preferably from 5 to 45 mgKOH/g. When the molecular weight is too low, heat-resistant storage stability and resistance to stress, such as that arising from agitation in developing device, of the toner may worsen. When the molecular weight is too high, viscoelasticity of the toner becomes too high when the toner is melted, degrading low-temperature fixability.

The weight average molecular weight is preferably from 2,500 to 20,000. The weight average molecular weight of the amorphous polyester resin (A2) and the amorphous resin (B) can be measured by gel permeation chromatography (GPC).

The glass transition temperature of each of the amorphous polyester resin (A2) and the amorphous resin (B) is preferably from 50 to 70° C. When the glass transition temperature is less than 50° C., heat-resistant storage stability and resistance to stress, such as that arising from agitation in developing device, of the toner may worsen. When the glass transition temperature exceeds 70° C., low-temperature fixability may worsen. The glass transition temperature of the amorphous polyester resin (A2) and the amorphous resin (B) can be measured by differential scanning calorimetry (DSC).

Specific examples of alcohol components for preparing the amorphous polyester resins include, but are not limited to, divalent alcohols (i.e., diols) such as alkylene glycols having a carbon number of 2 to 36 (e.g., ethylene glycol, 1,2-propylene glycol, 1,3-propylene glycol, 1,4-butylene glycol, 1,6-hexanediol); alkylene ether glycols having a carbon number of 4 to 36 (e.g., diethylene glycol, triethylene glycol, dipropylene glycol, polyethylene glycol, polypropylene glycol, polytetramethylene ether glycol); alicyclic diols having a carbon number of 6 to 36 (e.g., 1,4-cyclohexanedimethanol, hydrogenated bisphenol A); alkylene oxide having a carbon number of 2 to 4 (e.g., ethylene oxide (EO), propylene oxide (PO), butylene oxide (BO)) 1 to 30 mol adducts of the alicyclic diols; and alkylene oxide having a carbon number of 2 to 4 (e.g., EO, PO, BO) 2 to 30 mol adducts of bisphenols (e.g., bisphenol A, bisphenol F, bisphenol S).

Specific examples of alcohol components for preparing the amorphous polyester resins further include, but are not limited to, trivalent or more valent alcohols such as trivalent or more valent aliphatic polyols having a carbon number of 3 to 36 (e.g., alkanepolyol and intramolecular or intermolecular dehydration product thereof, such as glycerin, triethylolethane, trimethylolpropane, pentaerythritol, sorbitol, sorbitan, polyglycerin, and dipentaerythritol); sugars and derivatives thereof (e.g., sucrose, methyl glucoside); alkylene oxide having a carbon number of 2 to 4 (e.g., EO, PO, BO) 1 to 30 mol adducts of the aliphatic polyols; alkylene oxide having a carbon number of 2 to 4 (e.g., EO, PO, BO) 2 to 30 mol adducts of trisphenols (e.g., trisphenol PA); and alkylene oxide having a carbon number of 2 to 4 (e.g., EO, PO, BO) 2 to 30 mol adducts of novolac resins (e.g., phenol novolac, cresol novolac) having an average polymerization degree of 3 to 60.

Specific examples of carboxylic acid components for preparing the amorphous polyester resins include, but are not limited to, divalent carboxylic acids (i.e., dicarboxylic acids) such as alkane dicarboxylic acids having a carbon number of 4 to 36 (e.g., succinic acid, adipic acid, sebacic acid) and alkenyl succinic acid; alicyclic dicarboxylic acids having a carbon number of 4 to 36 (e.g., dimer acids such as dimeric linoleic acid); alkene dicarboxylic acids having a carbon number of 4 to 36 (e.g., maleic acid, fumaric acid, citraconic acid, mesaconic acid); and aromatic dicarboxylic acids having a carbon number of 8 to 36 (e.g., phthalic acid, isophthalic acid, terephthalic acid, derivatives thereof, and naphthalenedicarboxylic acid). Among these compounds, alkene dicarboxylic acids having a carbon number of 4 to 20 and aromatic dicarboxylic acids having a carbon number of 8 to 20 are preferable. Additionally, anhydrides and lower alkyl esters having a carbon number of 1 to 4 (e.g., methyl ester, ethyl ester, isopropyl ester) of the above-described compounds are also usable.

In addition, ring-opening polymerization products such as polylactic acid and polycarbonate diol are also preferable.

The molecular structure of these resins can be confirmed by means of solution or solid NMR, GC/MS, LC/MS, IR, etc.

Depending on the molecular composition, the amorphous resin (B) may gelate toner composition liquid gently and physically by association of molecules. In such a case, a resin dispersing a colorant forms a physical gel in the liquid. The colorant having been mechanically dispersed in the resin is captured inside the physical gel. Thus, the colorant is prevented from reaggregating in the liquid or bleeding out from the binder resin in the resulting toner. This is advantageous for a case in which yellow or magenta colorants, having a tendency to locally exist at the surface of toner, are used when the toner is prepared by dissolution suspension method, because localization of the colorants is prevented.

Whether the amorphous resin (B) forms a physical gel in a liquid or not can be confirmed by measuring the transmittance of its ethyl acetate solution including 20% by weight of solid contents having been left all day and all night at room temperature, with an absorption spectrometer having an optical path of 1 cm. When the transmittance is 50% or less, formation of the physical gel is confirmed.

The amorphous resin (B) is required to be compatible with the amorphous polyester resin (A2) for the copolymer resin (A). If these resins are incompatible with each other, the copolymer resin (A) and the amorphous resin (B) become phase-separated in the resulting toner particles. In this case, the colorant is contained inside the phase of the amorphous resin (B) without being distributed over the toner particles, causing color unevenness in the resulting fixed image.

Structural Unit Derived from Crystalline Polyester Resin (A1)

The crystalline polyester resin (A1) for the copolymer resin (A) is not limited to any particular resin. When the crystalline polyester resin (A1) is a crystalline polyester resin, the toner sharply melts at the time of fixing and keeps sufficient plasticity and durability even when the molecular weight is low. More preferably, the crystalline polyester resin is an aliphatic polyester resin that has excellent sharply-melting property. The aliphatic polyester resin is obtainable by a polycondensation reaction of a polyol component with a polycarboxylic acid component such as polycarboxylic acid, polycarboxylic acid anhydride, polycarboxylic acid ester, and/or a derivative thereof. In addition, ring-opening polymerization products such as polycaprolactone are also preferable.

The melting point of the crystalline polyester resin (A1) is preferably from 50 to 70° C. When the melting point is less than 50° C., the crystalline polyester resin (A1) is likely to melt at low temperatures, degrading heat-resistant storage stability of the toner. When the melting point exceeds 70° C., the crystalline polyester resin (A1) melts insufficiently upon application of heat at the fixing, degrading low-temperature fixability of the toner.

The hydroxyl value of the crystalline polyester resin (A1) is preferably from 5 to 40 mgKOH/g. When the molecular weight is too low, heat-resistant storage stability and resistance to stress, such as that arising from agitation in developing device, of the toner may worsen. When the molecular weight is too high, viscoelasticity of the toner becomes too high when the toner is melted, degrading low-temperature fixability. The weight average molecular weight is preferably from 3,000 to 30,000 and more preferably from 5,000 to 25,000. The weight average molecular weight of the crystalline polyester resin (A1) can be measured by gel permeation chromatography (GPC).

### Polyol

Specific examples of the polyol component include, but are not limited to, diols and trivalent or more valent alcohols.

Specific examples of the diols include, but are not limited to, saturated aliphatic diols. Specific examples of the saturated aliphatic diols include, but are not limited to, straight-chain saturated aliphatic diols and branched-chain saturated aliphatic diols. Among these diols, straight-chain saturated aliphatic diols are preferable, and those having a carbon number of 2 to 12 are more preferable. Branched-chain saturated aliphatic diols may reduce the crystallinity of the crystalline polyester resin and further reduce the melting point thereof. Saturated aliphatic diols having a carbon number more than 12 may be difficult to obtain. Thus, the carbon number is preferably 12 or less.

Specific examples of the saturated aliphatic diols include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. These compounds can be used alone or in combination.

Among these diols, ethylene glycol, 1,4-butanediol, 1,6-hexanediol, 1,8-octanediol, 1,10-decanediol, and 1,12-dodecanediol are preferable because the resulting crystalline polyester resin will have high crystallinity and sharply-melting property.

Specific examples of the trivalent or more valent alcohol include, but are not limited to, glycerin, trimethylolethane, trimethylolpropane, and pentaerythritol. These compounds can be used alone or in combination.

### Polycarboxylic Acid

Specific examples of the polycarboxylic acid component include, but are not limited to, divalent carboxylic acids and trivalent or more valent carboxylic acids.

Specific examples of the divalent carboxylic acids include, but are not limited to, saturated aliphatic dicarboxylic acids such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; aromatic dicarboxylic acids such as phthalic acid, isophthalic acid, terephthalic acid, naphthalene-2,6-dicarboxylic acid, malonic acid, and mesaconic acid; and anhydrides and lower alkyl esters (having a carbon number of 1 to 3) thereof. These compounds can be used alone or in combination.

Specific examples of the trivalent or more valent carboxylic acids include, but are not limited to, 1,2,4-benzenetricarboxylic acid, 1,2,5-benzenetricarboxylic acid, 1,2,4-naphthalenetricarboxylic acid, and anhydrides and lower alkyl esters (having a carbon number of 1 to 3) thereof. These compounds can be used alone or in combination.

Specific examples of the polycarboxylic acid component further include dicarboxylic acids having sulfonic groups and dicarboxylic acids having double bonds, other than the above-described saturated aliphatic dicarboxylic acids and aromatic dicarboxylic acids.

Preferably, the crystalline polyester resin (A1) is obtained by a polycondensation of a straight-chain saturated aliphatic dicarboxylic acid having a carbon number of 4 to 12 with a straight-chain saturated aliphatic diol having a carbon number of 2 to 12. In other words, the crystalline polyester resin (A1) preferably has a structural unit derived from a saturated aliphatic dicarboxylic acid having a carbon number of 4 to 12 and another structural unit derived from a saturated aliphatic diol having a carbon number of 2 to 12. Such a crystalline polyester resin (A1) has high crystallinity and sharply-melting property and gives low-temperature fixability to the toner.

The crystallinity, molecular structure, etc., of the crystalline polyester resin (A1) can be analyzed by means of NMR, differential scanning calorimetry (DSC), X-ray diffractometry, GC/MS, LC/MS, infrared absorption spectroscopy (IR), atomic force microscopy, etc.

### Copolymer Resin (A)

Production method of the copolymer resin (A) is not limited to any particular method. For example, the copolymer resin (A) can be produced by the following methods (1) to (4). From the viewpoint of the degree of freedom in molecular design, (1) and (3) are preferable and (1) is more preferable.

(1) A method in which the amorphous polyester resin (A2) having been prepared by a polymerization reaction and the crystalline polyester resin (A1) having been prepared by a polymerization reaction are dissolved or dispersed in a solvent and allowed to react with an elongation agent having 2 or more functional groups reactive with terminal hydroxyl or carboxylic group of polymer chain, such as isocyanate group, epoxy group, and carbodiimide group.
(2) A method in which the amorphous polyester resin (A2) having been prepared by a polymerization reaction and the crystalline polyester resin (A1) having been prepared by a polymerization reaction are melt-kneaded and subjected to an ester exchange reaction under reduced pressures.
(3) A method in which the crystalline polyester resin (A1) having been prepared by a polymerization reaction and monomers for preparing the amorphous polyester resin (A2) are melt-kneaded and subjected to an ester exchange reaction under reduced pressures.
(4) A method in which a ring-opening polymerization of the amorphous polyester resin (A2) is initiated from a polymer chain terminal of the crystalline polyester resin (A1) having been prepared by a polymerization reaction while hydroxyl groups in the crystalline polyester resin (A1) act as polymerization initiators.

The content rate of the crystalline polyester resin (A1) in the copolymer resin (A) is preferably from 30 to 60% by weight. When the content rate falls below 30% by weight, the amorphous segment exerts too large an influence. In a situation where neither fluidity nor deformability is required such as storage or conveyance process after the fixing process, the toner will effectively works. However, in a situation where fluidity is required such as the fixing process, the toner cannot exert sufficient fluidity and deformability. When the content rate exceeds 60% by weight, the crystalline segment exerts too large an influence, causing inversion of the microphase separation structure. In a situation where fluidity is required such as the fixing process, the toner will effectively works. However, in a situation where neither fluidity nor deformability is required such as storage or conveyance process after the fixing process, the molecular motion cannot be restrained.

The melting point of the copolymer resin (A) is preferably from 50 to 65° C. When the melting point is less than 50° C., the crystalline polyester resin (A1) is likely to melt at low temperatures, degrading heat-resistant storage stability of the toner. When the melting point exceeds 65° C., the crystalline polyester resin (A1) melts insufficiently upon application of heat at the fixing, degrading low-temperature fixability of the toner.

In view of cost and reactivity, specific preferred examples of the elongation agent include, but are not limited to, isocyanate compounds such as TDI, MDI, HDI, hydrogenated MDI, and IPDI. These compounds can be used alone or in combination.

The used amount of the elongation agent in preparing the copolymer resin (A) is determined so that the ratio of the total molar number of isocyanate to that of polyester polyol (NCO/OH) becomes from 0.50 to 0.75. When NCO/OH falls below 0.50, the binding force between the amorphous polyester resin (A2) and the crystalline polyester resin (A1) is so weak that these resins existing independently without binding increase in number. Thus, quality stability cannot be maintained. When NCO/OH exceeds 0.75, the molecular weight of the copolymer resin (A) and the interaction between the urethane groups have too large an influence. In a situation where neither fluidity nor deformability is required, the toner will effectively works. However, in a situation where fluidity is required such as fixing process, the toner cannot exert sufficient fluidity and deformability.

The weight average molecular weight of the copolymer resin (A) which can be measured by gel permeation chromatography (GPC) is preferably from 15,000 to 70,000. When the weight average molecular weight falls below 15,000, it means that the molecular weight of the system as a whole is so small that the toner cannot be given sufficient viscoelasticity. Although the fluidity is sufficient at the time of fixing, the viscosity is so low that the offset phenomenon may occur. In addition, the storage stability and rub resistance of the toner worsen. When the weight average molecular weight exceeds 70,000, the fluidity is too low to keep low-temperature fixability.

The molecular structure, crystallinity, and higher order structure, such as microphase separation structure, of the copolymer resin (A) can be readily analyzed by known methods. Specifically, these properties can be analyzed by means of high-resolution NMR (1H, 13C, etc.), differential scanning calorimetry (DSC), wide-angle X-ray diffractometry, (pyrolytic) GC/MS, LC/MS, infrared absorption spectroscopy (IR), atomic force microscopy, transmission electron microscopy (TEM), etc.

### Binder Resin

The binder resin is a mixture of the copolymer resin (A) and the amorphous resin (B). The amorphous resin (B) restrains the molecular motion in a situation where neither fluidity nor deformability is required such as storage or conveyance process after the fixing process. The copolymer resin (A) ensures fluidity and deformability in a situation where fluidity is required such as fixing process.

The content rate of the amorphous resin (B) in the binder resin is preferably from 30 to 70% by weight. When the content falls below 30% by weight, the crystalline segment exerts too large an influence, causing inversion of the microphase separation structure. In a situation where fluidity is required such as fixing process, the toner will effectively works. However, in a situation where neither fluidity nor deformability is required such as storage or conveyance process after the fixing process, the molecular motion cannot be restrained. When the content rate exceeds 70% by weight, the amorphous segment exerts too large an influence. In a situation where neither fluidity nor deformability is required such as storage or conveyance process after the fixing process, the toner will effectively works. However, in a situation where fluidity is required such as fixing process, the toner cannot exert sufficient fluidity and deformability.

The molecular structure, crystallinity, and higher order structure, such as microphase separation structure, of the binder resin can be readily analyzed by known methods. Specifically, these properties can be analyzed by means of high-resolution NMR (1H, 13C, etc.), differential scanning calorimetry (DSC), wide-angle X-ray diffractometry, (pyrolytic) GC/MS, LC/MS, infrared absorption spectroscopy (IR), atomic force microscopy, transmission electron microscopy (TEM), etc., in addition to separation operations such as solvent extraction, thermal extraction, etc.

### Crystalline Resin (C)

The binder resin may further include a crystalline resin (C), other than the structural unit derived from the crystalline polyester resin (A1) for the copolymer resin (A).

The crystalline resin (C) is not limited to any particular resin. However, the crystalline resin (C) is preferably a crystalline polyester resin. Specific preferred examples of the crystalline polyester resin include those preferable for the crystalline polyester resin (A1) described above.

### Properties of Toner and Binder Resin

### Properties Determined by Atomic Force Microscope (AFM)

When the binder resin is observed with an atomic force microscope (AFM) in tapping mode to obtain a phase image and the phase image is binarized by using an intermediate value between maximum and minimum phase difference values to obtain a binarized image, the binarized image consists of first phase-contrast images serving as large-phase-difference portions and second phase-contrast images serving as small-phase-difference portions with the first phase-contrast images dispersed in the second phase-contrast images forming a dot-like or streaky structure. The average value of the dispersion diameters, corresponding to the maximum Feret diameters, of the first phase-contrast images in the dot-like structure, or the widths, corresponding to the minimum Feret diameters, of the first phase-contrast images in the streaky structure, is less than 100 nm, more preferably not less than 10 nm and less than 100 nm.

More specifically, the average value is determined by the following procedures (I) to (III).

(I) Subject ten randomly-selected 300-nm-square phase images of the binder resin to the binarization processing.

(II) Measure the maximum Feret diameters of the first phase-contrast images in the dot-like structure or the minimum Feret diameters of the first phase-contrast images in the streaky structure in each of the ten binarized images.

(III) Average the top 30 maximum Feret diameters of the first phase-contrast images in the dot-like structure or the top 30 minimum Feret diameters of the first phase-contrast images in the streaky structure.

The structure in which the first phase-contrast images are dispersed in the second phase-contrast images in the binarized image of the phase image of the binder resin obtained by AFM is defined as a structure in which the boundary can be defined between the domains of the first and the second phase-contrast images. When the first phase-contrast images are too finely dispersed to be indistinguishable from image noise or a boundary cannot be determined between the domains of the first and the second phase-contrast images, it is confirmed that the dispersed structure is not established. When the first phase-contrast images are indistinguishable from image noise and a boundary cannot be determined between the domains of the first and the second phase-contrast images, it is impossible to determine Feret diameters.

When the domains of the first phase-contrast images are streaky and the maximum Feret diameter of each domain account for 300 nm or more, the minimum Feret diameter of each domain is employed as the domain diameter in place of the maximum Feret diameter.

In order to improve the toughness of the binder resin, a structure capable of relaxing external deformation or pressure should be introduced to the inside of the binder resin. One example of such a structure involves a structure with a higher softness. However, introduction of the softer structure will cause blocking such that toner particles fuse with each other when stored. In addition, the resulting image may have damage or fouling arising from the softness of the structure. To balance two opposite properties of toughness and relaxing property, the first phase-contrast images serving as large-phase-difference portions, capable of effectively acting on relaxing external deformation or pressure to improve toughness of the binder resin, are made finely dispersed in the second phase-contrast image serving as small-phase-difference portions.

Observation with AFM

The internal dispersion state of the binder resin can be confirmed from its phase image obtained with an atomic force microscope (AFM) in tapping mode. The detailed procedure for the measurement with AFM in tapping mode is described in Surface Science Letter, 290, 668 (1993). The phase image can be obtained by measuring the surface shape of sample while vibrating a cantilever as described in Polymer, 35, 5778 (1994) and Macromolecules, 28, 6773, (1995). Due to the viscoelastic property of the sample surface, a phase difference generates between a drive for vibrating the cantilever and the actual vibration. By mapping such phase differences, a phase image is obtainable. In soft portions, a phase delay is observed to be large. In hard portions, a phase delay is observed to be small.

One feature of the binder resin is that soft portions observed as large-phase-difference images are finely dispersed in hard portions observed as small-phase-difference images. The binder resin has a structure such that the second phase-contrast images serving as hard and small-phase-difference images constitute the outer phase and the first phase-contrast images serving as soft and large-phase-difference images constitute the inner phase with the first phase-contrast images finely dispersed in the second phase-contrast images. The sample for the AFM observation can be prepared by, for example, cutting the binder resin block into sections with ultramicrotome ULTRACUT UCT from Leica under the following conditions.
Cutting thickness: 60 nm
Cutting speed: 0.4 mm/sec
Knife: Diamond knife (Ultra Sonic 35°)

The AFM phase image can be obtained with, for example, an instrument MFP-3D from Asylum Research and a cantilever OMCL-AC240TS-C3 under the following conditions.
Target amplitude: 0.5 V
Target percent: −5%
Amplitude setpoint: 315 mV
Scan rate: 1 Hz
Scan points: 256×256
Scan angle: 0°

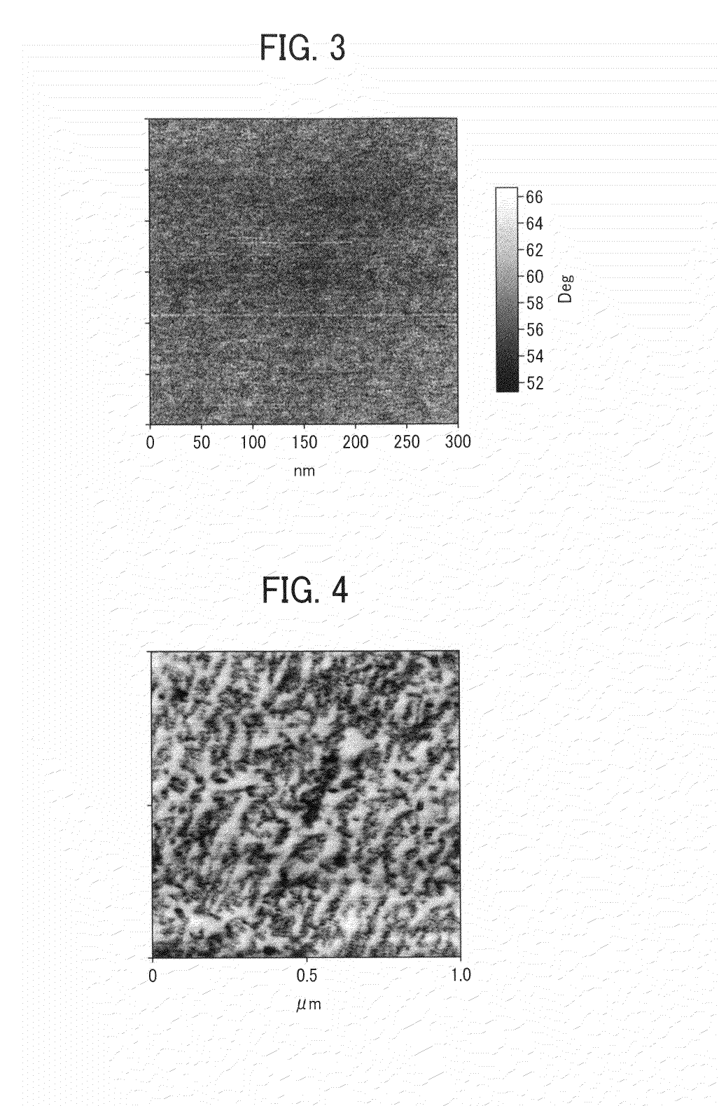

To determine the maximum Feret diameters of the first phase-contrast images serving as large-phase-difference portions (i.e., soft units), the binder resin should be first observed with AFM in tapping mode to obtain a phase image and then the phase image should be binarized by using an intermediate value between maximum and minimum phase difference values to obtain a binarized image. The phase image is photographed in such a way that the small-phase-difference portions are represented by dark colors while the large-phase-difference portions are represented by light colors. The phase image is then binarized by using an intermediate value between maximum and minimum phase difference values. Ten randomly-selected 300-nm-square phase images of the binder resin are subjected to the binarization processing and the top 30 maximum Feret diameters of the first phase-contrast images in the ten binarized images are averaged to determine the average value of the maximum Feret diameters. If the obtained image is an obvious image noise or is indistinguishable from image noise, as shown in FIG. 3, such image is excluded from the calculation of the average value. More specifically, among the first phase-contrast images in a dot-like or streaky structure, those having an area of one-hundredth or less of the area of the first phase-contrast image having the largest maximum Feret diameter in the same phase image are excluded from the calculation of the average value. The maximum Feret diameter is defined as the greatest distance between two parallel lines sandwiching the first phase-contrast image in a dot-like or streaky structure.

The average value of the maximum Feret diameters is less than 100 nm, preferably not less than 10 nm and less than 100 nm. When the average value of the maximum Feret diameters is 100 nm or more, adhesive units are likely to expose at the toner surface upon application of stress, which may decrease resistance to toner filming. When the average value of the maximum Feret diameters is less than 10 nm, the degree of relaxation of deformation or pressure significantly lowers, which may be ineffective for improving toughness. More preferably, the average value of the maximum Feret diameters is not less than 10 nm and not more than 45 nm.

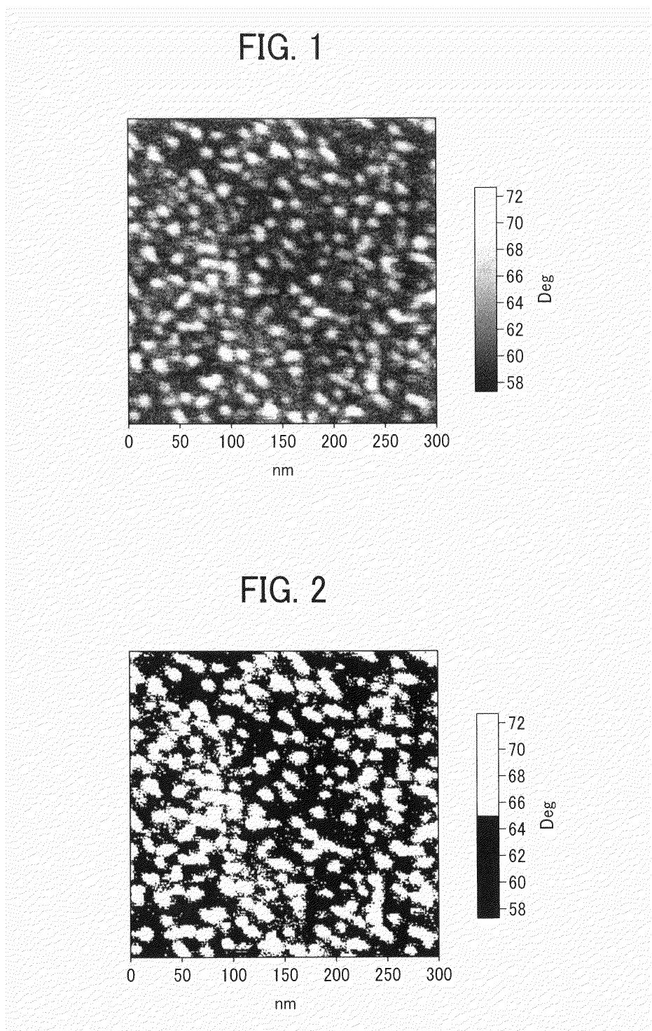

FIG. 1 is an example of a phase image of the binder resin according to an embodiment of the invention. FIG. 2 is a binarized image of the phase image of FIG. 1. Referring to FIG. 2, the bright regions represent the first phase-contrast images serving as large-phase-difference portions and the dark regions represent the second phase-contrast images consisting of small-phase-difference portions.

If the obtained image is an obvious image noise or indistinguishable from image noise, as shown in FIG. 3, data from such image is excluded from the calculation of the average value. More specifically, among the first phase-contrast images, those having an area of one-hundredth or less of the area of the first phase-contrast image having the largest maximum Feret diameter in the same phase image are excluded from the calculation of the average value. The maximum Feret diameter is defined as the greatest distance between two parallel lines sandwiching the first phase-contrast image.

When the domains of the first phase-contrast images are streaky and the maximum Feret diameter of each domain account for 300 nm or more, the minimum Feret diameter of each domain is employed as the domain diameter in place of the maximum Feret diameter. FIG. 4 is another example of a phase image of the binder resin according to an embodiment of the invention, having a streaky structure.

### Properties Determined by Pulsed NMR

According to an embodiment of the invention, a technique which chemically binds a crystalline segment and an amorphous segment together and restrains the molecular motion of the crystalline segment by controlling the structure of each segment is provided.

Pulsed nuclear magnetic resonance (NMR) is an effective measure for scaling molecular mobility. Unlike high-resolution NMR that provides chemical shift information (e.g., local chemical structure), pulsed NMR rapidly determines the relaxation times (i.e., spin-lattice relaxation time (T1) and spin-spin relaxation time (T2)) of 1H nuclear, having close relation to molecular mobility. In recent years, pulsed NMR have been in wide spread use.

Preferred measurement methods for pulsed NMR include, but are not limited to, Hahn echo method, solid echo method, CPMG method (i.e., Carr-Purcell-Meiboom-Gill method), and 90° pulse method. Since the toner and binder resin according to an embodiment of the invention have a moderate spin-spin relaxation time (T2), Hahn echo method is suitable. Generally, solid echo method and 90° pulse method are suitable for measuring short T2, Hahn echo method is suitable for measuring moderate T2, and CPMG method is suitable for measuring long T2.

The spin-spin relaxation time (t130) of the toner at 130° C. indicates the degree of molecular mobility at the time of fixing, relating to fixing property of the toner. The spin-spin relaxation time (t′70) of the toner at 70° C. when the toner is cooled from 130° C. to 70° C. indicates the degree of molecular mobility at the time of conveying the image, relating to rub resistance of the image. In a situation where fluidity is required, such as fixing process, the toner is required to have sufficient molecular mobility whereas in a situation where fluidity is not required, such as storage or conveyance process, it is required that the molecular motion is restrained.

The scale of the degree of molecular mobility relating to fixing property of the toner, i.e., the spin-spin relaxation time (t130), is preferably 12 ms or more. When t130 falls below 12 ms, it means that the molecular mobility upon application of heat is insufficient, decreasing fluidity and deformability of the toner and binder resin. As a result, image ductility and image connectivity to print objective may deteriorate, causing image deterioration such as gloss decline or image detachment.

The scale of the degree of molecular mobility relating to rub resistance of the image at the time of conveying the image, i.e., the spin-spin relaxation time (t′70), is preferably 0.8 ms or less. When t′70 exceeds 0.8 ms, the image is brought into contact or rubbing with roller or conveyance member in the paper discharge process after the fixing process before the molecular motion is sufficiently restrained, making scratches on the image and reducing the gloss of the image.

Measurement with Pulsed NMR

Measurement is performed with an instrument Minispec-MQ20 from Bruker Optics K.K. An attenuation curve is measured with a pulse sequence (90° x-Pi-180° x) according to Hahn echo method while setting the observing nuclear to 1H, resonant frequency to 19.65 MHz, and measurement interval to 5 s. Pi is from 0.01 to 100 ms, the number of data points is 100, the cumulated number is 32, and the measurement temperature is decreased from 130° C. to 70° C.

A sample tube is filled with 0.2 g of the toner powder or 0.2 g of the binder resin powder, being a major component in the toner, and adequately exposed to a magnetic field for the measurement. The spin-spin relaxation time (t130) and the spin-spin relaxation time (t′70) are determined by this procedure.

### Molecular Weight of Binder Resin

The copolymer resin (A) having a structural unit derived from the crystalline polyester resin (A1) and another structural unit derived from the amorphous polyester resin (A2) preferably has a volume average molecular weight (Mw) of from 20,000 to 150,000 in view of a balance between low-temperature fixability and heat-resistant storage stability. When Mw falls below 20,000, heat-resistant storage stability and hot offset resistance of the toner may deteriorate. When Mw exceeds 150,000, it is likely that the toner cannot melt sufficiently at low temperatures and the resulting image is easily detachable, causing deterioration of low-temperature fixability.

Molecular weight distribution and Mw of THF-soluble components of the toner or the binder resin can be measured with a gel permeation chromatographic instrument (such as HLC-8220 GPC from Tosoh Corporation). Triplet of 15-cm column TSKgel Super HZM-H is preferably used. First, prepare a 0.15% tetrahydrofuran (THF, containing a stabilizer, from Wako Pure Chemical Industries, Ltd.) solution of a sample resin. Filter the solution with 0.2-μm filter and use the filtrate as a specimen in succeeding procedures. Inject 100 μl of the specimen into the instrument and subject it to a measurement at 40° C. and a flow rate of 0.35 ml/min.

Determine molecular weight with reference to a calibration curve compiled from monodisperse polystyrene standard samples. As the polystyrene standard samples, Showdex STANDARD series from Showa Denko K.K. and toluene can be used. Prepare three kinds of THF solutions A, B, and C of monodisperse polystyrene standard samples having the following compositions and subject them to the measurement under the above-described conditions. Compile a calibration curve with light-scattering molecular weights of the monodisperse polystyrene standard samples that are represented by retention time for the peaks. As the detector, a refractive index (RI) detector is used.

Solution A: 2.5 mg of S-7450, 2.5 mg of S-678, 2.5 mg of S-46.5, 2.5 mg of S-2.90, and 50 ml of THF

Solution B: 2.5 mg of S-3730, 2.5 mg of S-257, 2.5 mg of S-19.8, 2.5 mg of S-0.580, and 50 ml of THF

Solution C: 2.5 mg of S-1470, 2.5 mg of S-112, 2.5 mg of S-6.93, 2.5 mg of toluene, and 50 ml of THF

### Other Toner Materials

### Colorant

There is no limit in the kind of colorant used for the toner.

Usable colorants are not limited in its color. The toner may include at least one of black, cyan, magenta, or yellow colorant.

Specific examples of black colorants include, but are not limited to, carbon blacks (C.I. Pigment Black 7) such as furnace black, lamp black, acetylene black, and channel black; metals such as copper, iron (C.I. Pigment Black 11), and titanium oxide; and organic pigments such as aniline black (C.I. Pigment Black 1).

Specific examples of magenta colorants include, but are not limited to, C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:1, 49, 50, 51, 52, 53, 53:1, 54, 55, 57, 57:1, 58, 60, 63, 64, 68, 81, 83, 87, 88, 89, 90, 112, 114, 122, 123, 150, 163, 177, 179, 184, 202, 206, 207, 209, 211, and 269; C.I. Pigment Violet 19; and C.I. Vat Red 1, 2, 10, 13, 15, 23, 29, and 35.

Specific examples of cyan colorants include, but are not limited to, C.I. Pigment Blue 2, 3, 15, 15:1, 15:2, 15:3, 15:4, 15:6, 16, 17, and 60; C.I. Vat Blue 6; and C.I. Acid Blue 45, a copper phthalocyanine pigment whose phthalocyanine skeleton is substituted with 1 to 5 phthalimide methyl groups, Green 7, and Green 36.

Specific examples of yellow colorants include, but are not limited to, C.I. Pigment Yellow 1, 2, 3, 4, 5, 6, 7, 10, 11, 12, 13, 14, 15, 16, 17, 23, 55, 65, 73, 74, 83, 97, 110, 139, 151, 154, 155, 180, and 185; and C.I. Vat Yellow 1, 3, 20, and Orange 36.

The content of the colorant is preferably from 1 to 15% by weight and more preferably from 3 to 10% by weight. When the content is less than 1% by weight, the coloring power of the toner may decrease. When the content exceeds 15% by weight, the colorant may be poorly dispersed in the toner, causing deterioration of the coloring power and electric properties of the toner.

The colorant may be combined with a resin to be used as a master batch. The resin is not limited to any particular resin, but the resin preferably has a similar structure to the binder resin in terms of compatibility.

The master batch may be obtained by mixing and kneading a resin and a colorant while applying a high shearing force. To increase the interaction between the colorant and the resin, an organic solvent may be used. More specifically, the maser batch may be obtained by a method called flushing in which an aqueous paste of the colorant is mixed and kneaded with the resin and the organic solvent so that the colorant is transferred to the resin side, followed by removal of the organic solvent and moisture. This method is advantageous in that the resulting wet cake of the colorant can be used as it is without being dried. When performing the mixing or kneading, a high shearing force dispersing device such as a three roll mill may be used.

### Release Agent

Specific examples of the release agent include, but are not limited to, carbonyl-group-containing wax, polyolefin wax, and long-chain hydrocarbon wax. These waxes can be used alone or in combination. Among these waxes, carbonyl-group-containing wax is preferable.

Specific examples of the carbonyl-group-containing wax include, but are not limited to, polyalkanoic acid ester, polyalkanol ester, polyalkanoic acid amide, polyalkyl amide, and dialkyl ketone.

Specific examples of the polyalkanoic acid ester include, but are not limited to, carnauba wax, montan wax, trimethylolpropane tribehenate, pentaerythritol tetrabehenate, pentaerythritol diacetate dibehenate, glycerin tribehenate, and 1,18-octadecanediol distearate. Specific examples of the polyalkanol ester include, but are not limited to, tristearyl trimellitate and distearyl maleate. Specific examples of the polyalkanoic acid amide include, but are not limited to, dibehenylamide. Specific examples of the polyalkyl amide include, but are not limited to, trimellitic acid tristearylamide. Specific examples of the dialkyl ketone include, but are not limited to, distearyl ketone. Among these carbonyl-group-containing waxes, polyalkanoic acid esters are preferable.

Specific examples of the polyolefin wax include, but are not limited to, polyethylene wax and propylene wax.

Specific examples of the long-chain hydrocarbon wax include, but are not limited to, paraffin wax and SASOL wax.

The melting point of the release agent is preferably from 50 to 100° C. and more preferably from 60 to 90° C. Release agents having a melting point less than 50° C. adversely affects heat-resistant storage stability. Release agents having a melting point greater than 100° C. are likely to cause cold offset in low-temperature fixing.

The melting point of the release agent can be measured by a differential scanning calorimeter (such as TA-60WS and DSC-60 from Shimadzu Corporation) as follows. First, about 5.0 mg of the release agent is put in an aluminum sample container. The container is put on a holder unit and set in an electric furnace. In nitrogen atmosphere, the sample is heated from 0° C. to 150° C. at a heating rate of 10° C./min, cooled to 0° C. at a cooling rate of 10° C./min, and reheated to 150° C. at a heating rate of 10° C./min, to obtain a DSC curve. The DSC curve is analyzed with analysis program in DSC-60 to determine the temperature at the maximum peak of melting heat in the second heating, corresponding to the melting point.

The melt viscosity at 100° C. of the release agent is preferably from 5 to 100 mPa·sec, more preferably from 5 to 50 mPa·sec, and most preferably from 5 to 20 mPa·sec. When the melt viscosity is less than 5 mPa·sec, releasability may deteriorate. When the melt viscosity is greater than 100 mPa·sec, hot offset resistance and releasability at low temperatures may deteriorate.

The content of the release agent is preferably from 1 to 20% by weight and more preferably from 3 to 10% by weight. When the content is less than 1% by weight, hot offset resistance may deteriorate. When the content exceeds 20% by weight, heat-resistant storage stability, chargeability, transferability, and resistance to stress may deteriorate.

### Charge Controlling Agent

The toner may include a charge controlling agent for giving charging ability to the toner, if needed.

Any known charge controlling agent is usable. There is a concern that a colored material may change the color tone of the toner. Therefore, colorless or whitish materials are preferable for the charge controlling agent. Specific examples of colorless or whitish charge controlling agents include, but are not limited to, triphenylmethane dyes, chelate pigments of molybdic acid, Rhodamine dyes, alkoxyamines, quaternary ammonium salts (including fluorine-modified quaternary ammonium salts), alkylamides, phosphor and phosphor-containing compounds, tungsten and tungsten-containing compounds, fluorine activators, metal salts of salicylic acid, and metal salts of salicylic acid derivatives. These compounds can be used alone or in combination.

The content of the charge controlling agent is determined according to the kind of binder resin, toner manufacturing method including dispersing method, etc., and is not limited to a particular value, but is preferably from 0.01 to 5% by weight, more preferably from 0.02 to 2% by weight. When the content of charge controlling agent exceeds 5% by weight, the toner charge is so large that the effect of the main charge controlling agent is reduced and electrostatic attracting force to a developing roller is increased. This may result in decline in developer fluidity and image density. When the content of charge controlling agent is less than 0.01% by weight, the initial rising of charge and the charge quantity of the toner is insufficient, adversely affecting the image quality.

### External Additive

For the purpose of improving fluidity, adjusting charge quantity, and/or adjusting electric properties, external additives may be added to the toner. Specific examples of the external additive include, but are not limited to, silica fine particles, hydrophobized silica fine particles, metal salts of fatty acids (e.g., zinc stearate, aluminum stearate), metal oxides (e.g., titania, alumina, tin oxide, antimony oxide) and hydrophobized products thereof, and fluoropolymers. Among these substances, hydrophobized silica fine particles, titania fine particles, and hydrophobized titania fine particles are preferable.

Specific examples of commercially-available silica fine particles include, but are not limited to, HDK H 2000, HDK H 2000/4, HDK H 2050EP, HVK 21, and HDK H 1303 (from Hoechst AG); and R972, R974, RX200, RY200, R202, R805, and R812 (from Nippon Aerosil Co., Ltd.). Specific examples of commercially-available titania fine particles include, but are not limited to, P-25 (from Nippon Aerosil Co., Ltd.); STT-30 and STT-65C-S (from Titan Kogyo, Ltd.); TAF-140 (from Fuji Titanium Industry Co., Ltd.); and MT-150W, MT-500B, MT-600B, and MT-150A (from TAYCA Corporation). Specific examples of commercially available hydrophobized titanium oxide fine particles include, but are not limited to, T-805 (from Nippon Aerosil Co., Ltd.); STT-30A and STT-65S-S (from Titan Kogyo, Ltd.); TAF-500T and TAF-1500T (from Fuji Titanium Industry Co., Ltd.); MT-100S and MT-100T (from TAYCA Corporation); and IT-S (from Ishihara Sangyo Kaisha, Ltd.).

The hydrophobized fine particles of silica, titania, and alumina can be obtained by treating fine particles of silica, titania, and alumina, which are hydrophilic, with a silane coupling agent such as methyltrimethoxysilane, methyltriethoxysilane, and octyltrimethoxysilane. Specific examples of usable hydrophobizing agents include, but are not limited to, silane coupling agents such as dialkyl dihalogenated silane, trialkyl halogenated silane, alkyl trihalogenated silane, and hexaalkyl disilazane; silylation agents; silane coupling agents having a fluorinated alkyl group; organic titanate coupling agents; aluminum coupling agents; silicone oils; and modified silicone oils.

The average primary particle diameter of these inorganic fine particles is typically from 1 to 100 nm and preferably from 3 to 70 nm. When the average primary particle diameter falls below 1 nm, the inorganic fine particle will be embedded in the toner and its functions cannot be effectively exhibited. When the average primary particle diameter exceeds 100 nm, the inorganic fine particle will unevenly make flaws on the surface of the electrostatic latent image bearing member. The external additive may be a combination of inorganic fine particles with hydrophobized inorganic fine particles. More preferably, the external additive includes at least two kinds of hydrophobized inorganic fine particles having an average primary particle diameter of 20 nm or less and at least one kind of hydrophobized inorganic fine particle having an average primary particle diameter of 30 nm or more. The BET specific surface area of the inorganic fine particle is preferably from 2 to 500 m²/g.

The content of the external additive is preferably from 0.1 to 5% by weight, more preferably from 0.3 to 3% by weight, based on the toner.

The external additive may include resin fine particles. For example, fine particles of polystyrene obtainable by soap-free emulsion polymerization, suspension polymerization, or dispersion polymerization; copolymers of methacrylates or acrylates; polycondensation polymers (e.g., silicone, benzoguanamine, nylon); and thermosetting resins are usable. Combination use of inorganic fine particles with resin particles improves the toner chargeability while reducing the amount of reversely-charged toner particles and the degree of background fouling. The content of the resin fine particles is preferably from 0.01 to 5% by weight, more preferably from 0.1 to 2% by weight, based on the toner.

### Fluidity Improving Agent

The external additive may be surface-treated with a fluidity improving agent to improve its hydrophobicity to prevent deterioration of fluidity and chargeability even under high-humidity conditions.

Specific examples of the fluidity improving agent include, but are not limited to, silane coupling agents, silylation agents, silane coupling agents having a fluorinated alkyl group, organic titanate coupling agents, aluminum coupling agents, silicone oils, and modified silicone oils.

### Cleanability Improving Agent

A cleanability improving agent may be added to the toner for improving removability of residual developer remaining on photoreceptor or primary transfer medium after image transfer.

Specific examples of the cleanability improving agent include, but are not limited to, metal salts of fatty acids (e.g., zinc stearate, calcium stearate) and resin fine particles prepared by soap-free emulsion polymerization (e.g., polymethyl methacrylate fine particles, polystyrene fine particles). Resin fine particles having a relatively narrow particle size distribution and a volume average particle diameter of from 0.01 to 1 μm are preferred.

### Magnetic Material

Specific examples of usable magnetic materials include, but are not limited to, iron powder, magnetite, and ferrite. Among these materials, those having a white color are preferred in terms of color tone.

### Production Method of Toner

The toner according to an embodiment of the present invention may be produced by, for example, a wet granulation method, such as dissolution suspension method and emulsion aggregation method, or a pulverization method. Dissolution suspension method and emulsion aggregation method are preferable because these methods do not include the process of kneading the binder resin, which is free from the problem of molecular cut caused by kneading or the difficulty of uniformly kneading high-molecular-weight resin with low-molecular-weight resin. Dissolution suspension method is more preferable in terms of uniformity of the binder resin in the toner particles.

### Dissolution Suspension Method

Dissolution suspension method includes the processes of dispersing or dissolving toner materials, including the above-described colorant, binder resin, and release agent, in an organic solvent to prepare a toner material liquid; and emulsifying the toner material liquid in an aqueous medium in the presence of a surfactant and resin fine particles.

### Organic Solvent

Volatile organic solvents having a boiling point less than 100° C. are preferred because they are easily removable after formation of mother toner particles. Specific examples of such organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These solvents can be used alone or in combination. Among these solvents, aromatic solvents such as toluene and xylene; halogenated hydrocarbons such as 1,2-dichloroethane, chloroform, and carbon tetrachloride; and ethyl acetate are preferable. The used amount of the organic solvent is typically 0 to 300 parts by weight, preferably from 0 to 100 parts by weight, and more preferably from 25 to 70 parts by weight, based on 100 parts by weight of the toner materials.

### Aqueous Medium

The aqueous medium may consist of water alone, or a mixture of water with an organic solvent such as an alcohol (e.g., methanol, isopropyl alcohol, ethylene glycol), dimethylformamide, tetrahydrofuran, a cellosolve (e.g., methyl cellosolve), or a lower ketone (e.g., acetone, methyl ethyl ketone).

The used amount of the aqueous medium is typically from 50 to 2,000 parts by weight and preferably from 100 to 1,000 parts by weight, based on 100 parts by weight of the toner material liquid. When the used amount is less than 50 parts by weight, the dispersion state of the toner material liquid is poor and toner particles having a desired particle size cannot be obtained. When the used amount exceeds 2,000 parts by weight, it is not economical.

### Surfactant and Resin Fine Particle

For improving the dispersibility of the colorant, binder resin, release agent, etc., dispersants such as surfactants and resin fine particles may be added to the aqueous medium.

Specific examples of the surfactant include, but are not limited to, anionic surfactants such as alkylbenzene sulfonate, α-olefin sulfonate, and phosphates; cationic surfactants such as amine salt type surfactants (e.g., alkylamine salts, amino alcohol fatty acid derivatives, polyamine fatty acid derivatives, imidazoline) and quaternary ammonium salt type surfactants (e.g., alkyl trimethyl ammonium salt, dialkyl dimethyl ammonium salt, alkyl dimethyl benzyl ammonium salt, pyridinium salt, alkyl isoquinolinium salt, and benzethonium chloride);

nonionic surfactants such as fatty acid amide derivatives and polyvalent alcohol derivatives; and ampholytic surfactants such as alanine, dodecyldi(aminoethyl)glycine, di(octylaminoethyl)glycine, and N-alkyl-N,N-dimethyl ammonium betaine.

Surfactants having a fluoroalkyl group can achieve their effect in small amounts. Specific preferred examples of usable anionic surfactants having a fluoroalkyl group include, but are not limited to, fluoroalkyl carboxylic acids having 2 to 10 carbon atoms and metal salts thereof, perfluorooctane sulfonyl glutamic acid disodium, 3-[ω-fluoroalkyl(C6-C11)oxy]-1-alkyl(C3-C4) sulfonic acid sodium, 3-[ω-fluoroalkanoyl(C6-C8)-N-ethylamino]-1-propane sulfonic acid sodium, fluoroalkyl(C11-C20) carboxylic acids and metal salts thereof, perfluoroalkyl(C7-C13) carboxylic acids and metal salts thereof, perfluoroalkyl(C4-C12) sulfonic acids and metal salts thereof, perfluorooctane sulfonic acid diethanol amide, N-propyl-N-(2-hydroxyethyl) perfluorooctane sulfonamide, perfluoroalkyl(C6-C10) sulfonamide propyl trimethyl ammonium salts, perfluoroalkyl(C6-C10)-N-ethyl sulfonyl glycine salts, and monoperfluoroalkyl(C6-C16) ethyl phosphates.

Specific examples of commercially available anionic surfactants having a fluoroalkyl group include, but are not limited to, SURFLON® S-111, S-112, and S-113 (from AGC Seimi Chemical Co., Ltd.); FLUORAD FC-93, FC-95, FC-98, and FC-129 (from Sumitomo 3 M); UNIDYNE DS-101 and DS-102 (from Daikin Industries, Ltd.); MEGAFACE F-110, F-120, F-113, F-191, F-812, and F-833 (from DIC Corporation); EFTOP EF-102, 103, 104, 105, 112, 123A, 123B, 306A, 501, 201, and 204 (from Mitsubishi Materials Electronic Chemicals Co., Ltd.); and FTERGENT F-100 and F-150 (from Neos Company Limited).

Specific examples of usable cationic surfactants include, but are not limited to, aliphatic primary, secondary, and tertiary amine acids having a fluoroalkyl group; aliphatic quaternary ammonium salts such as perfluoroalkyl(C6-C10) sulfonamide propyl trimethyl ammonium salts; benzalkonium salts; benzethonium chlorides; pyridinium salts; and imidazolinium salts. Specific examples of commercially available cationic surfactants having a fluoroalkyl group include, but are not limited to, SURFLON® S-121 (from AGC Seimi Chemical Co., Ltd.); FLUORAD FC-135 (from Sumitomo 3M); UNIDYNE DS-202 (from Daikin Industries, Ltd.); MEGAFACE F-150 and F-824 (from DIC Corporation); EFTOP EF-132 (from Mitsubishi Materials Electronic Chemicals Co., Ltd.); and FTERGENT F-300 (from Neos Company Limited).

### Resin Fine Particle

Every resins capable of forming their aqueous dispersion can be used as the resin fine particles, including thermoplastic resins and thermosetting resins. Specific examples of usable resins include, but are not limited to, vinyl resin, polyurethane resin, epoxy resin, polyester resin, polyamide resin, polyimide resin, silicone resin, phenol resin, melamine resin, urea resin, aniline resin, ionomer resin, and polycarbonate resin. Two or more of these resins can be used in combination.

Among these resins, vinyl resin, polyurethane resin, epoxy resin, polyester resin, and combinations thereof are preferable because aqueous dispersions of fine spherical particles thereof are easily obtainable. Specific examples of the vinyl resin include, but are not limited to, homopolymers and copolymers of vinyl monomers, such as styrene-acrylate copolymer, styrene-methacrylate copolymer, styrene-butadiene copolymer, acrylic acid-acrylate copolymer, methacrylic acid-acrylate copolymer, styrene-acrylonitrile copolymer, styrene-maleic anhydride copolymer, styrene-acrylic acid copolymer, and styrene-methacrylic acid copolymer. The average particle diameter of the resin fine particle is typically from 5 to 200 nm and preferably from 20 to 300 nm. Inorganic compound dispersants such as tricalcium phosphate, calcium carbonate, titanium oxide, colloidal silica, and hydroxyapatite are also usable.

### Dispersant

Additionally, polymeric protection colloids are usable in combination with the above-described resin fine particles and/or inorganic compound dispersants to stabilize dispersing liquid droplets. Specific examples of usable polymeric protection colloids include, but are not limited to, homopolymers and copolymers obtained from monomers, such as acids (e.g., acrylic acid, methacrylic acid, α-cyanoacrylic acid, α-cyanomethacrylic acid, itaconic acid, crotonic acid, fumaric acid, maleic acid, maleic anhydride), hydroxyl-group-containing acrylates and methacrylates (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate), vinyl alcohols and vinyl alcohol ethers (e.g., vinyl methyl ether, vinyl ethyl ether, vinyl propyl ether), esters of vinyl alcohols with carboxyl-group-containing compounds (e.g., vinyl acetate, vinyl propionate, vinyl butyrate), amides (e.g., acrylamide, methacrylamide, diacetone acrylamide) and methylol compounds thereof (e.g., N-methylol acrylamide, N-methylol methacrylamide), acid chlorides (e.g., acrylic acid chloride, methacrylic acid chloride), and monomers containing nitrogen or a nitrogen-containing heterocyclic ring (e.g., vinyl pyridine, vinyl pyrrolidone, vinyl imidazole, ethylene imine); polyoxyethylenes (e.g., polyoxyethylene, polyoxypropylene, polyoxyethylene alkylamine, polyoxypropylene alkylamine, polyoxyethylene alkylamide, polyoxypropylene alkylamide, polyoxyethylene nonyl phenyl ether, polyoxyethylene lauryl phenyl ether, polyoxyethylene stearyl phenyl ester, polyoxyethylene nonyl phenyl ester); and celluloses (e.g., methyl cellulose, hydroxyethyl cellulose, hydroxypropyl cellulose).

Dispersing Method Specific examples of dispersing methods include, but are not limited to, methods using any of the following: low-speed shearing type, high-speed shearing type, frictional type, high-pressure jet type, and ultrasonic type. To adjust the particle diameter of the dispersing elements to 2 to 20 μm, a high-speed shearing type disperser is preferable. When a high-speed shearing type disperser is used, the revolution is typically from 1,000 to 30,000 rpm and preferably from 5,000 to 20,000 rpm. The dispersing time for a batch type disperser is typically from 0.1 to 5 minutes, but is not limited thereto. The dispersing temperature is typically from 0 to 150° C. (under pressure) and preferably from 40 to 98° C.

### Removal of Organic Solvent, Washing, and Drying

The emulsion (i.e., reactant) is subjected to the removal of the organic solvent and subsequent washing and drying to obtain mother toner particles.

To remove the organic solvent, the reaction system is gently heated while being agitated in laminar flow, with a strong agitation given within a certain temperature range. As a result of such a removal process, spindle-shaped mother toner particles are prepared. In a case in which an acid-soluble or base-soluble substance, such as calcium phosphate, is used as a dispersion stabilizer, the mother toner particles are first washed with an acid (e.g., hydrochloric acid) to dissolve the dispersion stabilizer and then with water to wash it away. Alternatively, such a dispersion stabilizer can be removed by being decomposed by an enzyme. To the surfaces of the mother toner particles, a charge controlling agent is fixed and then external additives, i.e., inorganic fine particles such as silica fine particles and titanium oxide fine particles, are adhered. The fixation of charge controlling agent and the adherence of external additives are performed by any known methods.

The ratio of the volume average particle diameter to the number average particle diameter of the toner is preferably from 1.0 to 1.4 and more preferably from 1.0 to 1.3 in view of the uniformity of particle diameter. The volume average particle diameter of the toner is preferably from 0.1 to 16 μm, depending on the purpose of use. With respect to the upper limit, 11 μm is more preferable and 9 μm is most preferable. With respect to the lower limit, 0.5 μm is more preferable and 1 μm is most preferable. The volume average particle diameter and number average particle diameter can be measured at the same time with an instrument MULTISIZER III (from Beckman Coulter, Inc.).

### Measurement of Particle Diameter

The measurement of volume and number average particle diameters can be made with an instrument such as COULTER COUNTER TA-II, COULTER MULTISIZER II, and COULTER MULTISIZER III (from Beckman Coulter, Inc.) in the following manner.

First, 0.1 to 5 ml of a surfactant (preferably an alkylbenzene sulfonate), as a dispersant, is added to 100 to 150 ml of an electrolyte. Here, the electrolyte is an about 1% NaCl aqueous solution prepared with the first grade sodium chloride, such as ISOTON-II (available from Beckman Coulter, Inc.). Further, 2 to 20 mg of a sample is added thereto. The electrolyte, in which the sample is suspended, is subjected to a dispersion treatment with an ultrasonic disperser for about 1 to 3 minutes and then to the measurement of the volume and number of toner particles with the above instrument and a 100-μm aperture to calculate volume and number distributions. Further, the volume average particle diameter and number average particle diameter are calculated from the volume and number distributions.

Thirteen channels with the following ranges are used for the measurement: not less than 2.00 μm and less than 2.52 μm; not less than 2.52 μm and less than 3.17 μm; not less than 3.17 μm and less than 4.00 μm; not less than 4.00 μm and less than 5.04 μm; not less than 5.04 μm and less than 6.35 μm; not less than 6.35 μm and less than 8.00 μm; not less than 8.00 μm and less than 10.08 μm; not less than 10.08 μm and less than 12.70 μm; not less than 12.70 μm and less than 16.00 μm; not less than 16.00 μm and less than 20.20 μm; not less than 20.20 μm and less than 25.40 μm; not less than 25.40 μm and less than 32.00 μm; and not less than 32.00 μm and less than 40.30 μm. Namely, particles having a particle diameter not less than 2.00 μm and less than 40.30 μm are to be measured.

### Emulsion Aggregation Method

Emulsion aggregation method includes the processes of aggregating and fusing the binder resin, colorant, release agent, each in the form of dispersing elements, to obtain a toner slurry; washing and filtering the toner slurry to collect toner particles; and drying it to isolate the toner particles.

### Pulverization Method

Pulverization method includes the processes of mechanically mixing toner constituents including the binder resin, release agent, and colorant; melt-kneading the mixture; pulverizing the melt-kneaded mixture into particles; and classifying the particles by size. Among the particles obtained in the processes of pulverizing and classifying, those deemed inappropriate for the commercial product can be recycled in the process of mechanically mixing or melt-kneading.

The process of mechanically mixing toner constituents may be performed by a mixer equipped with agitation blades under normal conditions, but the process is not limited thereto. The resulting mixture is set in a kneader and subjected to the process of melt-kneading.

The kneader may be a single-axis or double-axis continuous kneader or a batch kneader using roll mill. Specific examples of commercially available kneaders include, but are not limited to, TWIN SCREW EXTRUDER KTK from Kobe Steel, Ltd., TWIN SCREW COMPOUNDER TEM from Toshiba Machine Co., Ltd., MIRACLE K.C.K from Asada Iron Works Co., Ltd., TWIN SCREW EXTRUDER PCM from Ikegai Co., Ltd., and KOKNEADER from Buss Corporation. The process of melt-kneading should be performed under the conditions that the molecular chains of the binder resin are not cut. When the melt-kneading temperature is too lower than the softening point of the binder resin, the molecular chains are cut. When the melt-kneading temperature is too higher than the softening point of the binder resin, dispersion of toner constituents such as charge controlling agent and colorant will not well advance. It is preferable that the melt-kneading temperature is set according to the softening point of the binder resin.

After the process of melt-kneading, the kneaded mixture is pulverized into particles. Preferably, the kneaded mixture is first pulverized into coarse particles and then into fine particles. Specific examples of the pulverization method include, but are not limited to, a method in which particles are brought into collision with a collision plate in jet stream; a method in which particles are brought into collision with each other; and a method in which particles are put in a narrow gap between mechanically-rotating rotor and stator. The resulting particles are then classified in air stream by means of centrifugal force, etc., to obtain toner particles having a desired particle diameter.

The toner can also be produced by a method of producing particles described in Japanese Patent No. 4531076. The method includes the processes of dissolving toner constituents in liquid or supercritical carbon dioxide and removing the liquid or supercritical carbon dioxide to obtain toner particles.

### Developer

The developer according to an embodiment includes at least the toner according to an embodiment, and optionally a carrier and other components. The developer may be either one-component developer or two-component developer. For use in high-speed printers corresponding to recent improvement in information processing speed, two-component developer is preferable because of its extended useful lifespan.

In the one-component developer according to an embodiment, the average toner size may not vary very much although consumption and supply of toner particles are repeated. Additionally, the toner particles are prevented from filming a developing roller (developer bearing member) or adhering to a toner layer regulating member (blade). Thus, stable developability and image are provided for an extended period of time. In the two-component developer according to an embodiment, the average toner size may not vary very much although consumption and supply of toner particles are repeated over a long period. Thus, stable developability is provided for an extended period of time.

### Carrier

The carrier is not limited in composition. Preferably, the carrier is composed of a core material and a covering layer covering the core material.

### Core Material

The core material is composed of a magnetic particle such as ferrite, magnetite, iron, and nickel. With respect to ferrites, considering recent increasing attention to environmental applicability, manganese ferrite, manganese-magnesium ferrite, manganese-strontium ferrite, manganese-magnesium-strontium ferrite, and lithium ferrite are preferred rather than copper-zinc ferrite that has been used so far.

### Covering Layer

The covering layer includes at least a binder resin, and optionally an inorganic fine particle and other components.

### Binder Resin

Specific examples of the binder resin for the covering layer include, but are not limited to, polyolefins (e.g., polyethylene, propylene) and their modified products; styrene-acrylic resins; cross-linked copolymers including acrylonitrile, vinyl acetate, vinyl alcohol, vinyl chloride, vinyl carbazole, vinyl ether, etc.; silicone resins having organosiloxane bonds and their modified products (e.g., alkyd-resin-modified, polyester-resin-modified, epoxy-resin-modified, polyurethane-modified, polyimide-modified); polyamide; polyester; polyurethane; polycarbonate; urea resins; melamine resins; benzoguanamine resins; epoxy resins; ionomer resins; polyimide resins; and derivatives thereof. These compounds can be used alone or in combination. Among these resins, silicone resins are preferable.

Specific examples of the silicone resins include, but are not limited to, straight silicone resins consisting of organosiloxane bonds only and silicone resins modified with alkyd, polyester, epoxy, acrylic resin, or urethane.

Specific examples of the straight silicone resins include, but are not limited to, KR271, KR272, KR282, KR252, KR255, and KR152 (from Shin-Etsu Chemical Co., Ltd.); and SR2400, SR2405, and SR2406 (from Dow Corning Toray Co., Ltd.). Specific examples of the modified silicone resins include, but are not limited to, ES-1001N (epoxy-modified), KR-5208 (acrylic-modified), KR-5203 (polyester-modified), KR-206 (alkyd-modified), and KR-305 (urethane-modified) (from Shin-Etsu Chemical Co., Ltd.); and SR2115 (epoxy-modified) and SR2110 (alkyd-modified) (from Dow Corning Toray Co., Ltd.).

These silicone resins can be used alone or in combination with cross-linking components, charge controlling components, etc. Specific examples of the cross-linking components include, but are not limited to, silane coupling agents. Specific examples of the silane coupling agents include, but are not limited to, methyl trimethoxysilane, methyl triethoxysilane, octyl trimethoxysilane, and aminosilane coupling agents.

### Fine Particles

The covering layer may include fine particles, if needed. Specific examples of the fine particles include, but are not limited to, inorganic fine particles of metal powder, tin oxide, zinc oxide, silica, titanium oxide, alumina, potassium titanate, barium titanate, aluminum borate, etc.; and organic fine particles of conductive polymers such as polyaniline, polyacetylene, polyparaphenylene, poly(para-phenylenesulfide), polypyrrole, and parylene, and carbon black.

The fine particles may be subjected to a surface conductive treatment. The surface conductive treatment may be a method in which the surface of the fine particle is covered with a material such as aluminum, zinc, copper, nickel, silver, a mixed metal thereof, zinc oxide, titanium oxide, tin oxide, antimony oxide, indium oxide, bismuth oxide, tin-doped indium oxide, antimony-doped tin oxide, and zirconium oxide, in the form of solid solution or fusion. Among these materials, tin oxide, indium oxide, and tin-doped indium oxide are preferable for the surface conductive treatment.

The content rate of the covering layer in the carrier is preferably 5% by weight or more and more preferably from 5 to 10% by weight.

The thickness of the covering layer is preferably from 0.1 to 5 μm and more preferably from 0.3 to 2 μm.

The thickness of the covering layer can be measured by, for example, preparing cross sections of the carrier particles by focused ion beam (FIB), observing 50 or more of the cross sections with a transmission electron microscope (TEM) or a scanning transmission electron microscope (STEM), and averaging the measured thickness values.

### Method of Forming Covering Layer

The method of forming the covering layer is not limited to any particular method. The method may include, for example, dissolving raw materials of the covering layer including the binder resin or a precursor thereof to prepare a covering layer liquid, and applying the covering layer liquid to the surface of the core material by an atomizing method or a dipping method. After the covering layer liquid is applied to the surface of the core material, it is preferable that a heating treatment is conducted so that a polymerization reaction of the binder resin or a precursor thereof is accelerated. Such a heating treatment may be conducted within a coater shortly after the application of the covering layer is completed or by another heating means such as electric furnace and burning kiln.

The heating treatment temperature is determined depending on the constituting materials of the covering layer, but is preferably from 120 to 350° C. and more preferably less than or equal to the decomposition temperatures of the constituting materials. The upper limit of the decomposition temperatures of the constituting materials is preferably 220° C. The heating treatment time is preferably from 5 to 120 minutes.

### Properties of Carrier

The volume average particle diameter of the carrier is preferably from 10 to 100 μm and more preferably from 20 to 65 μm.

When the volume average particle diameter is less than 10 μm, carrier deposition may occur due to decline in uniformity of the core particles. When the volume average particle diameter exceeds 100 μm, reproducibility of image detail deteriorate and high-definition image is not produced.

The volume average particle diameter can be measured by a particle size analyzer such as Microtrac HRA9320-X100 (from Nikkiso Co., Ltd.).

The volume resistivity of the carrier is preferably from 9 to 16 log(Ω·cm) and more preferably from 10 to 14 log(Ω·cm).

When the volume resistivity is less than 9 log(Ω·cm), carrier deposition may occur at non-image portions. When the volume resistivity is greater than 16 log(Ω·cm), the edge effect, in which the image density at the edge portion is increased, notably occurs. The volume resistivity is adjustable by adjusting the thickness of the covering layer or the content of the conductive particles in the covering layer.

The volume resistivity can be measured as follows. Fill a fluororesin cell with the carrier. The cell contains a pair of electrodes with an area of 2.5 cm×4 cm and an interelectrode distance of 0.2 cm. Tap the cell at a tapping height of 1 cm and a tapping speed of 30 times/min for 10 times. Apply a direct-current voltage of 1,000 V to between the electrodes. Thirty seconds later, measure the resistance r (Ω) with High Resistance Meter 4329A (from Hewlett-Packard Japan, Ltd.) and calculate the volume resistivity R (log(Ω·cm)) from the following formula.

R=Log [r×(2.5 cm×4 cm)/0.2 cm]

In the two-component developer according to an embodiment, the ratio of toner to carrier is preferably from 2.0 to 12.0% by weight and more preferably from 2.5 to 10.0% by weight.

The two-component developer according to an embodiment can be used as a supplementary developer by adjusting the ratio of toner to carrier.

When the supplementary developer is used for the type of image forming apparatus which discharges surplus developer from developing device during image formation, a constant image quality is provided for an extended period of time.

More specifically, since deteriorated carrier particles contained in the developing device are replaced with fresh carrier particles in the supplementary developer, the charge quantity and image quality can be kept constant for an extended period of time. This type of image forming apparatus is effective in printing high-image-area image. Deterioration in the quality of high-image-area image printing is mainly caused due to deterioration in charging ability of spent carrier particles deteriorated by toner particle. In this type of image forming apparatus, even in high-image-area image printing, a large amount of fresh carrier particles are supplied and replaced with deteriorated carrier particles with a high frequency. Accordingly, a constant image quality is provided for an extended period of time.

In the supplementary developer, the amount of toner is preferably from 2 to 50 parts by weight and more preferably from 5 to 12 parts by weight based on 1 part of carrier. When the amount of toner is less than 2 parts by weight, supplementation of fresh carrier particles is excessive and the carrier content in the developing device becomes too high, increasing the charge quantity of the toner. As the charge quantity of the toner increases, the developing ability deteriorates to reduce image density. When the amount of toner exceeds 50 parts by weight, supplementation of fresh carrier particles is insufficient and refreshment of deteriorated carrier particles cannot be expected.

### Image Forming Method and Image Forming Apparatus

An image forming method according to an embodiment includes at least electrostatic latent image forming process, developing process, transfer process, and fixing process, and optionally other processes such as neutralization process, cleaning process, recycle process, and control process.

An image forming apparatus according to an embodiment includes at least an electrostatic latent image bearing member, an electrostatic latent image forming device, a developing device, a transfer device, and a fixing device, and optionally other devices such as a neutralizer, a cleaner, a recycler, and a controller.

### Electrostatic Latent Image Forming Process and Electrostatic Latent Image Forming Device

The electrostatic latent image forming process is a process in which an electrostatic latent image is formed on an electrostatic latent image bearing member.

The electrostatic latent image bearing member (hereinafter may be referred to as “electrophotographic photoreceptor” or simply “photoreceptor”) is not limited in material, shape, structure, and size. The shape is preferably a drum-like shape. Specific examples of usable materials include, but are not limited to, inorganic photoconductors such as amorphous silicon and selenium and organic photoconductors such as polysilane and phthalopolymethine. Among these materials, amorphous silicon is preferable in terms of long operating life.

An electrostatic latent image can be formed by, for example, uniformly charging a surface of the electrostatic latent image bearing member and irradiating the surface with light containing image information by the electrostatic latent image forming device.

The electrostatic latent image forming device includes at least a charger to uniformly charge a surface of the electrostatic latent image bearing member and an irradiator to irradiate the surface of the photoreceptor with light containing image information.

A surface of the electrostatic latent image bearing member can be charged by applying a voltage to the surface of the photoreceptor by the charger.

Specific examples of the charger include, but are not limited to, contact chargers equipped with conductive or semiconductive roller, brush, film, or rubber blade and non-contact chargers employing corona discharge such as corotron and scorotron.

Preferably, the charger is disposed in or out of contact with the electrostatic latent image bearing member to charge the surface of the electrostatic latent image bearing member by applying a direct-current voltage superimposed on an alternating-current voltage.

Preferably, the charger is a charging roller disposed close to without contacting the electrostatic latent image bearing member by the intermediary of a gap tape to charge the surface of the electrostatic latent image bearing member by applying a direct-current voltage superimposed on an alternating-current voltage.

The surface of the electrostatic latent image bearing member can be irradiated with light containing image information by the irradiator.

Specific examples of the irradiator include, but are not limited to, various irradiators of radiation optical system type, rod lens array type, laser optical type, and liquid crystal shutter optical type.

It is also possible that a back surface of the electrostatic latent image bearing member is irradiated with light containing image information.

### Developing Process and Developing Device

The developing process is a process in which the electrostatic latent image is developed into a visible image with the toner or developer according to an embodiment of the invention.

The visible image can be formed by, for example, developing the electrostatic latent image with the toner or developer by the developing device.

The developing device is not limited in configuration so long as the toner or developer is used for development. For example, a developing device capable of storing the toner or developer and supplying the toner or developer to the electrostatic latent image either by contact with or without contact with the electrostatic latent image is preferable.

The developing device may be used for either monochrome development or multicolor development. For example, a developing device including an agitator to frictionally agitate the toner or developer to charge it and a rotatable magnet roller is preferable.

In such a developing device, the toner and carrier particles are mixed and agitated and the toner particles are charged by friction. The charged toner particles are retained on the surface of the rotating magnet roller in the form of ears, forming magnetic brush. The magnet roller is disposed adjacent to the electrostatic latent image bearing member (photoreceptor) so that a part of the toner particles composing the magnetic brush formed on the surface of the magnet roller are moved to the surface of the electrostatic latent image bearing member (photoreceptor) by electric attractive force. As a result, the electrostatic latent image is developed with the toner particles to form a visible image on the surface of the electrostatic latent image bearing member (photoreceptor).

The developer stored in the developing device is the above-described developer according to an embodiment.

### Transfer Process and Transfer Device

The transfer process is a process in which the visible image is transferred onto a recording medium. It is preferable that the visible image is primarily transferred onto an intermediate transfer medium and then secondarily transferred onto the recording medium. Preferably, at least two toners with different colors, more preferably multiple toners for full-color printing, are used in the transfer process, and the transfer process includes a primary transfer process in which multiple visible images with different colors are transferred onto an intermediate transfer medium to form a composite image and a secondary transfer process in which the composite image is transferred onto a recording medium.

The visible image can be transferred by the transfer device by, for example, charging the electrostatic latent image bearing member (photoreceptor) by a transfer charger. The transfer device preferably includes a primary transfer device to transfer a visible image onto an intermediate transfer medium to form a composite image and a secondary transfer device to transfer the composite image onto a recording medium.

Specific examples of the intermediate transfer medium include, but are not limited to, transfer belt.

The transfer device preferably includes a transferrer to separate the visible image formed on the electrostatic latent image bearing member (photoreceptor) to the recording medium side by charging. The number of the transferrer is at least one.

Specific examples of the transferrer include, but are not limited to, corona transferrer, transfer belt, transfer roller, pressure transfer roller, and adhesive transferrer.

Specific examples of the recording medium include, but are not limited to, recording paper.

### Fixing Process and Fixing Device

The fixing process is a process in which the visible image transferred onto the recording medium is fixed thereon by the fixing device. The fixing process may be performed either every time each color toner is transferred onto the recording medium or at once after all color toners are superimposed on one another.

The fixing device is not limited in configuration but preferably includes a heat-pressure member. Specific examples of the heat-pressure member include, but are not limited to, a combination of a heat roller and a pressure roller; and a combination of a heat roller, a pressure roller, and an endless belt.

Preferably, the fixing device includes a heating member equipped with a heat generator, a film in contact with the heating member, and a pressure member pressed against the heating member with the film therebetween, for allowing an unfixed image formed on a recording medium to pass through between the film and the pressure member so that the image is fixed on the recording medium by heat. The heating temperature is normally from 80 to 200° C.

The fixing device may be used together with or replaced with an optical fixer. The neutralization process is a process in which neutralization bias is applied to the electrostatic latent image bearing member to neutralize the electrostatic latent image bearing member and is preferably performed by a neutralizer.

The neutralizer is not limited in configuration so long as neutralization bias can be applied. Specific examples of the neutralizer include, but are not limited to, neutralization lamp.

The cleaning process is a process in which residual toner particles remaining on the electrostatic latent image bearing member are removed and is preferably performed by a cleaner.

The cleaner is not limited in configuration so long as residual toner particles remaining on the electrostatic latent image bearing member can be removed. Specific examples of the cleaner include, but are not limited to, magnetic brush cleaner, electrostatic brush cleaner, magnetic roller cleaner, blade cleaner, brush cleaner, and web cleaner.

The recycle process is a process in which the toner particles removed in the cleaning process are recycled by the developing device and is preferably performed by a recycler. The recycler is not limited in configuration. Specific examples of the recycler include, but are not limited to, conveyor.

The control process is a process in which the above-described processes are controlled and is preferably performed by a controller.

The controller is not limited in configuration so long as the above-described processes can be controlled. Specific examples of the controller include, but are not limited to, sequencer and computer.

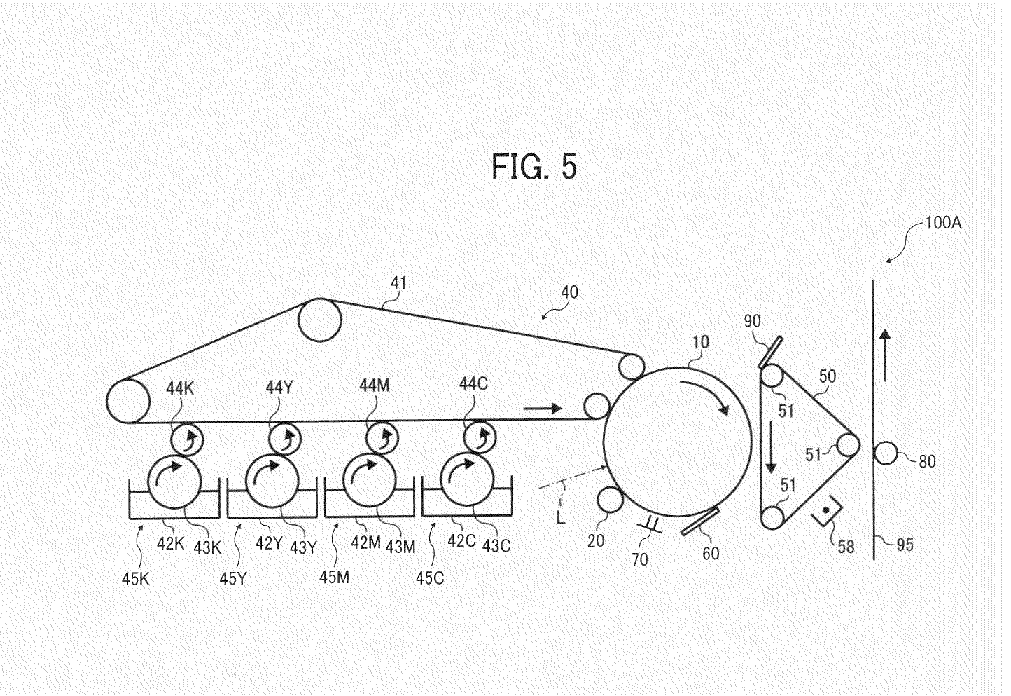

FIG. 5 is a schematic view of an image forming apparatus according to an embodiment of the invention. A full-color image forming apparatus 100A includes a photoreceptor drum 10 (hereinafter “photoreceptor 10”) serving as the electrostatic latent image bearing member, a charging roller 20 serving as the charger, an irradiator serving as the irradiator, a developing device 40 serving as the developing device, an intermediate transfer belt 50, a cleaner 60 equipped with a cleaning blade serving as the cleaner, and a neutralization lamp 70 serving as the neutralizer.

The intermediate transfer belt 50 is in the form of an endless belt and is stretched taut by three rollers 51 disposed inside the loop of the endless belt. The intermediate transfer belt 50 is movable in the direction indicated by arrow in FIG. 5. A part of the three rollers 51 also function(s) as transfer bias roller(s) capable of applying a predetermined transfer bias (primary transfer bias) to the intermediate transfer belt 50. A cleaner 90 equipped with a cleaning blade is disposed adjacent to the intermediate transfer belt 50. A transfer roller 80 capable of applying a transfer bias (secondary transfer bias) to a transfer paper 95 for transferring the toner image on the transfer paper 95 is disposed facing the intermediate transfer belt 50. Around the intermediate transfer belt 50, a corona charger 58 to give charge to the toner image on the intermediate transfer belt 50 is disposed between the contact point of the intermediate transfer belt 50 with the photoreceptor 10 and the contact point of the intermediate transfer belt 50 with the transfer paper 95 relative to the direction of rotation of the intermediate transfer belt 50.

The developing device 40 includes a developing belt 41; and a black developing unit 45K, a yellow developing unit 45Y, a magenta developing unit 45M, and a cyan developing unit 45C each disposed around the developing belt 41. The black developing unit 45K contains a developer container 42K, developer supplying roller 43K, and a developing roller 44K. The yellow developing unit 45Y contains a developer container 42Y, developer supplying roller 43Y and a developing roller 44Y. The magenta developing unit 45M contains a developer container 42M, developer supplying roller 43M, and a developing roller 44M. The cyan developing unit 45C contains a developer container 42C, developer supplying roller 43C, and a developing roller 44C. The developing belt 41 is in the form of an endless belt and stretched taut by multiple belt rollers. The developing belt 41 is movable in the direction indicated by arrow in FIG. 5. A part of the developing belt 41 is in contact with the photoreceptor 10.

The image forming apparatus 100A forms image in the following manner. First, the charging roller 20 uniformly charges a surface of the photoreceptor 10 and the irradiator irradiates the surface of the photoreceptor 10 with light L to form an electrostatic latent image. The electrostatic latent image formed on the photoreceptor 10 is developed into a toner image with toner supplied from the developing device 40. The toner image formed on the photoreceptor 10 is primarily transferred onto the intermediate transfer belt 50 by a transfer bias applied from the roller 51 and then secondarily transferred onto the transfer paper 95 by a transfer bias applied from the transfer roller 80. After the toner image is transferred onto the intermediate transfer belt 50, residual toner particles remaining on the photoreceptor 10 are removed by the cleaner 60 and then the residual charge remaining on the photoreceptor is removed by the neutralization lamp 70.

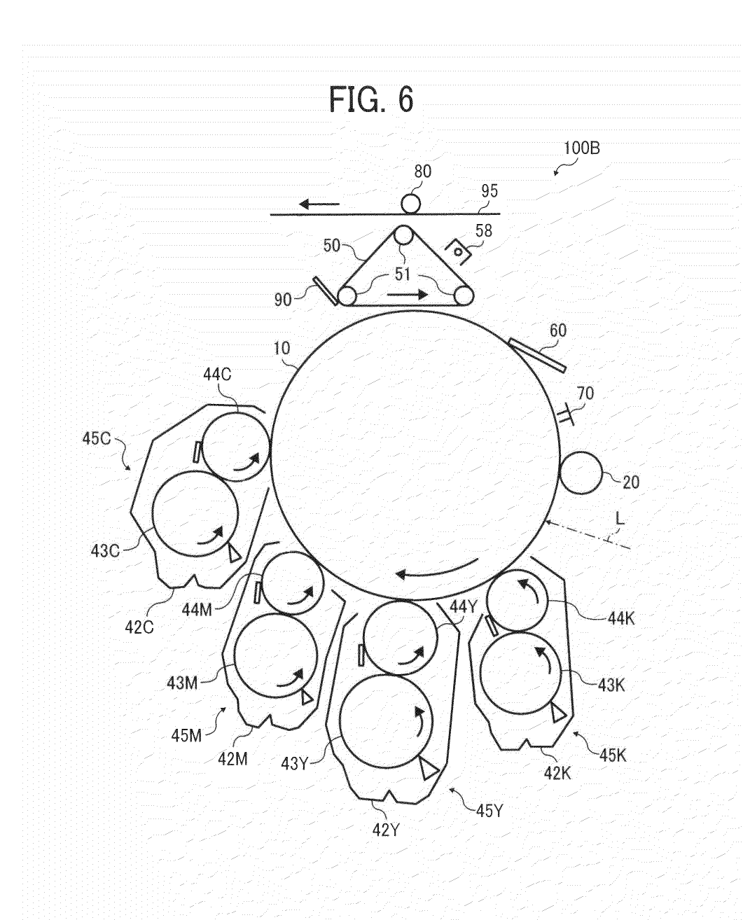

FIG. 6 is a schematic view of an image forming apparatus according to an embodiment of the invention. An image forming apparatus 100B has the same configuration as the image forming apparatus 100A except that the developing belt 41 is eliminated and the black developing unit 45K, yellow developing unit 45Y, magenta developing unit 45M, and cyan developing unit 45C are each disposed facing the photoreceptor 10.

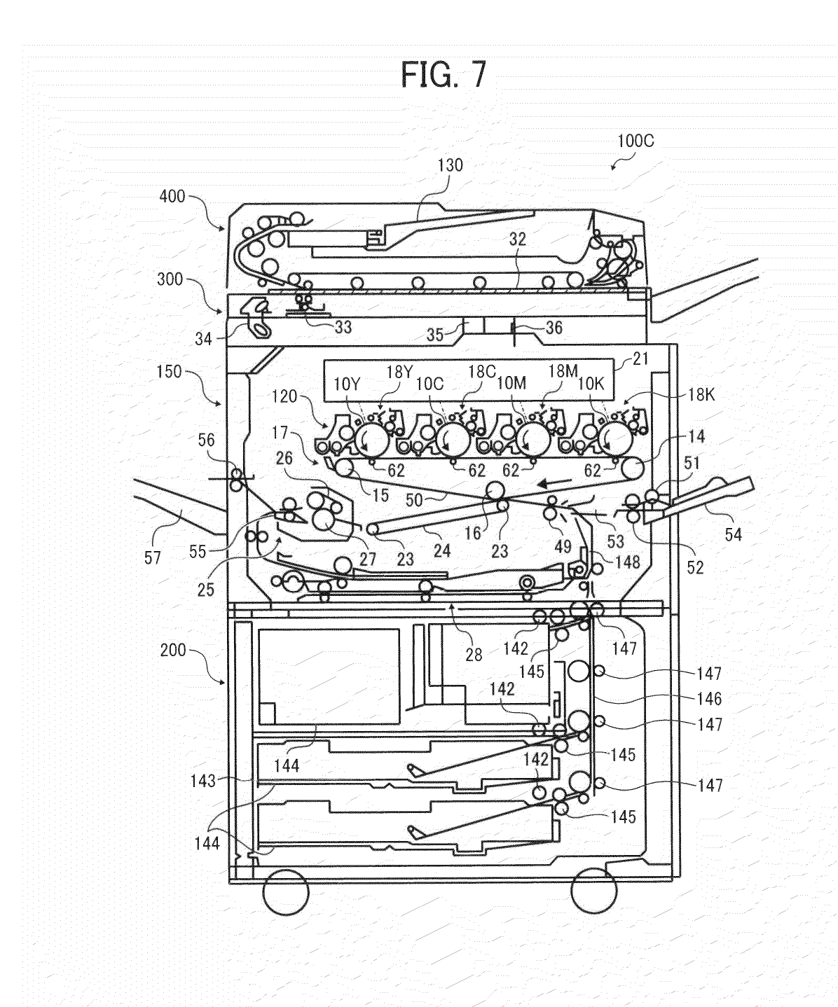

FIG. 7 is a schematic view of an image forming apparatus according to an embodiment of the invention. An image forming apparatus 100C, which is of a tandem-type full-color image forming apparatus, includes a main body 150, a paper feed table 200, a scanner 300, and an automatic document feeder (ADF) 400.

An intermediate transfer belt 50 is disposed at the center of the main body 150. The intermediate transfer belt 50 is in the form of an endless belt and stretched taut by three rollers 14, 15, and 16 disposed inside the loop of the endless belt. The intermediate transfer belt 50 is movable in the direction indicated by arrow in FIG. 7. A cleaner 17 for removing residual toner particles remaining on the intermediate transfer belt 50 without being transferred onto a recording medium is disposed adjacent to the roller 15. Image forming units 18Y, 18C, 18M, and 18K to produce respective images of yellow, cyan, magenta, and black are arranged in tandem along a surface of the intermediate transfer belt 50 stretched between the support rollers 14 and 15, constituting a tandem image forming part 120. An irradiator 21 is disposed adjacent to the tandem image forming part 120. A secondary transfer belt 24 is disposed on the opposite side of the tandem image forming part 120 relative to the intermediate transfer belt 50. The secondary transfer belt 24 is in the form of a seamless belt and is stretched taut with a pair of rollers 23. Recording paper to be conveyed on the secondary transfer belt 24 and the intermediate transfer belt 50 are contactable with each other between the rollers 16 and 23. A fixing device 25 is disposed adjacent to the secondary transfer belt 24. The fixing device 25 includes a fixing belt 26 in the form of a seamless belt stretched taut with a pair of rollers and a pressing roller 27 pressed against the fixing belt 26. A sheet reversing device 28 is disposed adjacent to the secondary transfer belt 24 and the fixing device 25 to reverse a sheet of recording paper upside down so that images can be formed on both sides of the sheet.

The image forming apparatus 100C forms full-color image in the following manner. A document is set on a document table 130 of the automatic document feeder 400 or on a contact glass 32 of the scanner 300 while the automatic document feeder 400 is lifted up, followed by holding down of the automatic document feeder 400. As a switch is pressed, in a case in which a document is set on the contact glass 32, the scanner 300 immediately starts driving to run a first runner 33 equipped with a light source and a second runner 34 equipped with a mirror. In a case in which a document is set on the automatic document feeder 400, the scanner 300 starts driving after the document is fed onto the contact glass 32. The first runner 33 directs light to the document and reflects a light reflected from the document toward the second runner 24. The second runner 34 reflects the light toward a reading sensor 36 through an imaging lens 35. Thus, the document is read and converted into image information of yellow, cyan, magenta, and black.

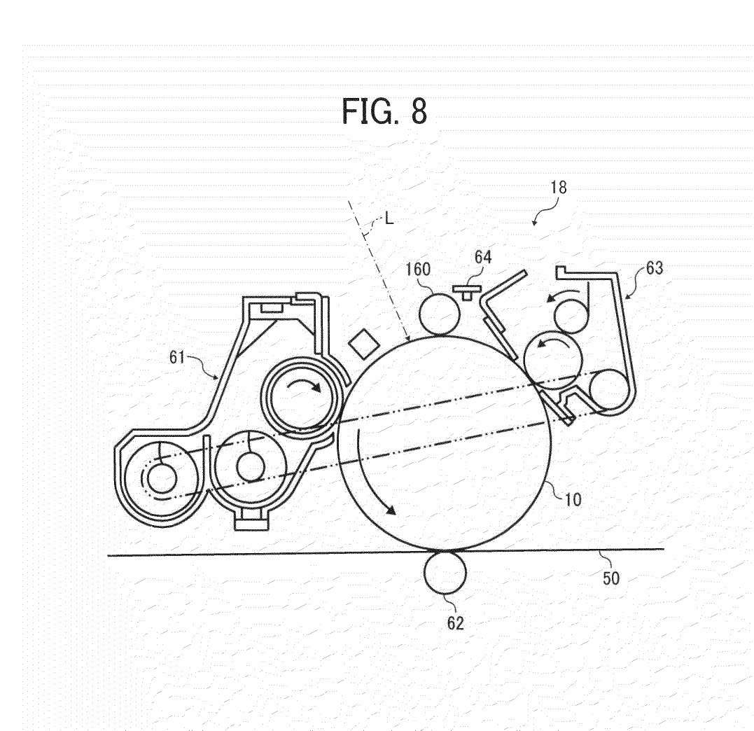

The image information of each color is transmitted to the corresponding image forming unit 18Y, 18C, 18M, or 18K to form a toner image of each color. FIG. 8 is a magnified schematic view of each of the image forming units 18Y, 18C, 18M, and 18K. In FIG. 8, additional characters Y, C, M, and K representing toner colors of yellow, cyan, magenta, and black, respectively, are omitted for the sake of simplicity. Each of the image forming units 18 includes a photoreceptor 10, a charging roller 160 to uniformly charge the photoreceptor 10, an irradiator to irradiate the photoreceptor 10 with light L to form an electrostatic latent image, a developing device 61 to develop the electrostatic latent image with a corresponding color toner, a transfer roller 62 to transfer the toner image onto the intermediate transfer belt 50, a cleaner 63 equipped with a cleaning blade, and a neutralizer 64.

The toner images formed in the image forming units 18Y, 18C, 18M, and 18K are primarily and sequentially transferred onto the moving intermediate transfer belt 50, stretched with the rollers 14, 15, and 16, to form a composite toner image.

On the other hand, as the switch is pressed, one of paper feed rollers 142 starts rotating in the paper feed table 200 to feed sheets of recording paper from one of paper feed cassettes 144 in a paper bank 143. One of separation rollers 145 separates the sheets one by one and feeds them to a paper feed path 146. Feed rollers 147 feed each sheet to a paper feed path 148 in the main body 150. The sheet is stopped upon striking a registration roller 49.

Alternatively, a feed roller 51 starts rotating to feed sheets from a manual feed tray 54. A separation roller 52 separates the sheets one by one and feeds them to a manual paper feed path 53. The sheet is stopped upon striking the registration roller 49. The registration roller 49 is generally grounded. Alternatively, it is possible that the registration roller 49 is applied with a bias for the purpose of removing paper powders from the recording paper. The registration roller 49 starts rotating to feed the sheet to between the intermediate transfer belt 50 and the secondary transfer belt 24 in synchronization with an entry of the composite toner image formed on the intermediate transfer belt 50 thereto so that the composite toner image can be transferred onto the sheet of recording paper. Residual toner particles remaining on the intermediate transfer belt 50 after image transfer are removed by the cleaner 17.

The sheet of recording paper having the composite toner image thereon is conveyed by the secondary transfer belt 24 toward the fixing device 25 to fix the composite toner image on the sheet. The switch claw 55 switches paper feed paths so that the sheet is discharged by the discharge roller 56 onto the discharge tray 57. Alternatively, the switch claw 55 may switch paper feed paths so that the sheet is introduced into the sheet reversing device 28. In the sheet reversing device 28, the sheet gets reversed to record another image on the back side of the sheet. Thereafter, the sheet is discharged by the discharge roller 56 onto the discharge tray 57.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### Resin Synthesis Example 1

### Amorphous Polyester Resin (A2) for Copolymer Resin

A 5-liter four-neck flask equipped with a nitrogen inlet pipe, a dewatering pipe, a stirrer, and a thermocouple is charged with propylene glycol as a diol and dimethyl terephthalate and dimethyl adipate as dicarboxylic acids, with the molar ratio of dimethyl terephthalate to dimethyl adipate being 85/15 and the ratio of OH groups to COOH groups being 1.2. The flask contents are allowed to react in the presence of 300 ppm of titanium tetraisopropoxide while the produced methanol is allowed to flow out. The reaction system is eventually heated to 230° C. and the reaction is continued until the resin acid value becomes 5 or less. The reaction is further continued for 4 hours under reduced pressures of from 20 to 30 mmHg. Thus, a linear polyester resin is prepared. The resin has an acid value (AV) of 0.80 mgKOH/g, a hydroxyl value (OHV) of 26.7 mgKOH/g, a Tg of 51.2° C., and an Mw of 7,500.

### Resin Synthesis Example 2

### Amorphous Polyester Resin (A2) for Copolymer Resin

A 5-liter four-neck flask equipped with a nitrogen inlet pipe, a dewatering pipe, a stirrer, and a thermocouple is charged with propylene glycol as a diol and dimethyl terephthalate and dimethyl adipate as dicarboxylic acids, with the molar ratio of dimethyl terephthalate to dimethyl adipate being 90/10 and the ratio of OH groups to COOH groups being 1.2. The flask contents are allowed to react in the presence of 300 ppm of titanium tetraisopropoxide while the produced methanol is allowed to flow out. The reaction system is eventually heated to 230° C. and the reaction is continued until the resin acid value becomes 5 or less. The reaction is further continued for 4 hours under reduced pressures of from 20 to 30 mmHg. Thus, a linear polyester resin is prepared. The resin has an acid value (AV) of 0.70 mgKOH/g, a hydroxyl value (OHV) of 27.8 mgKOH/g, a Tg of 59.2° C., and an Mw of 7,400.

### Resin Synthesis Example 3

### Amorphous Polyester Resin (A2) for Copolymer Resin

A 5-liter four-neck flask equipped with a nitrogen inlet pipe, a dewatering pipe, a stirrer, and a thermocouple is charged with propylene glycol as a diol and dimethyl terephthalate as a dicarboxylic acid, with the ratio of OH groups to COOH groups being 1.2. The flask contents are allowed to react in the presence of 300 ppm of titanium tetraisopropoxide while the produced methanol is allowed to flow out. The reaction system is eventually heated to 230° C. and the reaction is continued until the resin acid value becomes 5 or less. The reaction is further continued for 4 hours under reduced pressures of from 20 to 30 mmHg. Thus, a linear polyester resin is prepared. The resin has an acid value (AV) of 0.76 mgKOH/g, a hydroxyl value (OHV) of 22.3 mgKOH/g, a Tg of 69.7° C., and an Mw of 7,800.

### Resin Synthesis Example 4

### Crystalline Polyester Resin (A1) for Copolymer Resin

A 5-liter four-neck flask equipped with a nitrogen inlet pipe, a dewatering pipe, a stirrer, and a thermocouple is charged with 1,6-hexanediol as a diol and adipic acid as a dicarboxylic acid, with the ratio of OH groups to COOH groups being 1.1. The flask contents are subjected to dehydration condensation in the presence of 300 ppm of titanium tetraisopropoxide. The reaction system is eventually heated to 230° C. and the reaction is continued until the resin acid value becomes 5 or less. The reaction is further continued for 4 hours under reduced pressures of 10 mmHg or less. Thus, a linear polyester resin is prepared. The resin has an acid value (AV) of 0.76 mgKOH/g, a hydroxyl value (OHV) of 28.3 mgKOH/g, a Tm of 56.3° C., and an Mw of 21,000.

### Resin Synthesis Example 5

### Crystalline Polyester Resin (A1) for Copolymer Resin

A 5-liter four-neck flask equipped with a nitrogen inlet pipe, a dewatering pipe, a stirrer, and a thermocouple is charged with 1,4-butanediol as a diol and adipic acid as a dicarboxylic acid, with the ratio of OH groups to COOH groups being 1.1. The flask contents are subjected to dehydration condensation in the presence of 300 ppm of titanium tetraisopropoxide. The reaction system is eventually heated to 230° C. and the reaction is continued until the resin acid value becomes 5 or less. The reaction is further continued for 4 hours under reduced pressures of 10 mmHg or less. Thus, a linear polyester resin is prepared. The resin has an acid value (AV) of 0.76 mgKOH/g, a hydroxyl value (OHV) of 26.4 mgKOH/g, a Tm of 62.3° C., and an Mw of 24,000.

### Resin Synthesis Example 6

### Crystalline Polyester Resin (A1) for Copolymer Resin

A 5-liter four-neck flask equipped with a nitrogen inlet pipe, a dewatering pipe, a stirrer, and a thermocouple is charged with 1,6-hexanediol as a diol and sebacic acid as a dicarboxylic acid, with the ratio of OH groups to COOH groups being 1.1. The flask contents are subjected to dehydration condensation in the presence of 300 ppm of titanium tetraisopropoxide. The reaction system is eventually heated to 230° C. and the reaction is continued until the resin acid value becomes 5 or less. The reaction is further continued for 4 hours under reduced pressures of 10 mmHg or less. Thus, a linear polyester resin is prepared. The resin has an acid value (AV) of 0.76 mgKOH/g, a hydroxyl value (OHV) of 31.4 mgKOH/g, a Tm of 68.5° C., and an Mw of 18,500.

### Resin Synthesis Example 7

The procedure in Resin Synthesis Example 1 is repeated except for changing the ratio OH/COOH to 1.15 to obtain a resin. The resin has an acid value (AV) of 0.98 mgKOH/g, a Tg of 55.1° C., and an Mw of 13,000.

### Resin Synthesis Example 8

A 5-liter four-neck flask equipped with a nitrogen inlet pipe, a dewatering pipe, a stirrer, and a thermocouple is charged with a mixture of ethylene oxide 2 mol adduct of bisphenol A with propylene oxide 3 mol adduct of bisphenol A at a molar ratio of 90/10 and dimethyl isophthalate as an acid component, with the ratio of OH groups to COOH groups being 1.2. The flask contents are allowed to react in the presence of 500 ppm of titanium tetraisopropoxide for 10 hours at 230° C. under normal pressure and subsequent 5 hours under reduced pressures of from 10 to 15 mmHg. Thus, a linear polyester resin is prepared. The resin has an acid value (AV) of 0.34 mgKOH/g, a Tg of 56.0° C., and an Mw of 8,600.

### Resin Synthesis Example 9

A 5-liter four-neck flask equipped with a nitrogen inlet pipe, a dewatering pipe, a stirrer, and a thermocouple is charged with a mixture of ethylene glycol with 1,3-butanediol at a molar ratio of 1/1 and dimethyl terephthalate as an acid component, with the ratio of OH groups to COOH groups being 1.2. The flask contents are allowed to react in the presence of 500 ppm of titanium tetraisopropoxide for 10 hours at 230° C. under normal pressure and subsequent 5 hours under reduced pressures of from 10 to 15 mmHg. Thus, a linear polyester resin is prepared. The resin has an acid value (AV) of 0.48 mgKOH/g, a Tg of 56.2° C., and an Mw of 11,000.

### Resin Synthesis Example 10

A 5-liter four-neck flask equipped with a nitrogen inlet pipe, a dewatering pipe, a stirrer, and a thermocouple is charged with a mixture of ethylene oxide 2 mol adduct of bisphenol A with propylene oxide 3 mol adduct of bisphenol A at a molar ratio of 40/60 and a mixture of terephthalic acid with adipic acid at a molar ratio of 95/5, with the ratio of OH groups to COOH groups being 1.2. The flask contents are allowed to react in the presence of 500 ppm of titanium tetraisopropoxide for 10 hours at 230° C. under normal pressure and subsequent 5 hours under reduced pressures of from 10 to 15 mmHg. After adding 30 parts of trimellitic anhydride to the flask, the flask contents are allowed to react for 1 hour at 180° C. under normal pressure. Thus, a linear polyester resin is prepared. The resin has an acid value (AV) of 0.65 mgKOH/g, a Tg of 60.7° C., and an Mw of 7,200.

### Resin Synthesis Example 11

A 5-liter four-neck flask equipped with a nitrogen inlet pipe, a dewatering pipe, a stirrer, and a thermocouple is charged with a mixture of propylene glycol with 1,3-propanediol at a molar ratio of 75/25 and dimethyl terephthalate as an acid component, with the ratio of OH groups to COOH groups being 1.2. The flask contents are allowed to react in the presence of 500 ppm of titanium tetraisopropoxide for 10 hours at 230° C. under normal pressure and subsequent 2 hours under reduced pressures of from 10 to 15 mmHg. Thus, a linear polyester resin is prepared. The resin has an acid value (AV) of 0.53 mgKOH/g, a Tg of 61.0° C., and an Mw of 7,300.

### Resin Synthesis Example 12

A 5-liter four-neck flask equipped with a nitrogen inlet pipe, a dewatering pipe, a stirrer, and a thermocouple is charged with a mixture of ethylene oxide 2 mol adduct of bisphenol A with propylene oxide 3 mol adduct of bisphenol A at a molar ratio of 40/60 and dimethyl terephthalate as an acid component, with the ratio of OH groups to COOH groups being 1.15. The flask contents are allowed to react in the presence of 500 ppm of titanium tetraisopropoxide for 10 hours at 230° C. under normal pressure and subsequent 5 hours under reduced pressures of from 10 to 15 mmHg. Thus, a linear polyester resin is prepared. The resin has an acid value (AV) of 0.81 mgKOH/g, a Tg of 68.5° C., and an Mw of 8,700.

### Resin Synthesis Example 13

A 5-liter four-neck flask equipped with a nitrogen inlet pipe, a dewatering pipe, a stirrer, and a thermocouple is charged with a mixture of propylene glycol with 1,3-propanediol at a molar ratio of 75/25 and dimethyl terephthalate as an acid component, with the ratio of OH groups to COOH groups being 1.2. The flask contents are allowed to react in the presence of 500 ppm of titanium tetraisopropoxide for 10 hours at 230° C. under normal pressure and subsequent 5 hours under reduced pressures of from 10 to 15 mmHg. Thus, a linear polyester resin is prepared. The resin has an acid value (AV) of 0.41 mgKOH/g, a Tg of 68.2° C., and an Mw of 9,000.

### Resin Synthesis Example 14

A 5-liter four-neck flask equipped with a nitrogen inlet pipe, a dewatering pipe, a stirrer, and a thermocouple is charged with propylene glycol as a diol and a mixture of dimethyl terephthalate with fumaric acid as dicarboxylic acids at a molar ratio of 75/25, with the ratio of OH groups to COOH groups being 1.3. The flask contents are allowed to react in the presence of 300 ppm of titanium tetraisopropoxide while the produced methanol and water are allowed to flow out. The reaction system is eventually heated to 230° C. and the reaction is continued until the resin acid value becomes 5 or less. The reaction is further continued for 4 hours under reduced pressures of from 20 to 30 mmHg. After adding 30 parts of trimellitic anhydride to the flask, the flask contents are allowed to react for 1 hour at 180° C. under normal pressure. Thus, a linear polyester resin is prepared. The resin has an acid value (AV) of 19.1 mgKOH/g, a Tg of 55.4° C., and an Mw of 6,000.

### Resin Synthesis Example 15

A 5-liter four-neck flask equipped with a nitrogen inlet pipe, a dewatering pipe, a stirrer, and a thermocouple is charged with a mixture of ethylene oxide 2 mol adduct of bisphenol A with propylene oxide 3 mol adduct of bisphenol A at a molar ratio of 85/15 and a mixture of isophthalic acid with adipic acid at a molar ratio of 80/20, with the ratio of OH groups to COOH groups being 1.3. The flask contents are allowed to react in the presence of 500 ppm of titanium tetraisopropoxide for 10 hours at 230° C. under normal pressure and subsequent 5 hours under reduced pressures of from 10 to 15 mmHg. After adding 30 parts of trimellitic anhydride to the flask, the flask contents are allowed to react for 1 hour at 180° C. under normal pressure. Thus, a linear polyester resin is prepared. The resin has an acid value (AV) of 18.2 mgKOH/g, a Tg of 52.8° C., and an Mw of 5,400.

### Resin Synthesis Example 16

A 5-liter four-neck flask equipped with a nitrogen inlet pipe, a dewatering pipe, a stirrer, and a thermocouple is charged with a mixture of propylene glycol with 1,3-propanediol at a molar ratio of 1/1 and a mixture of dimethyl terephthalate with dimethyl isophthalate at a molar ratio of 1/1 as acid components, with the ratio of OH groups to COOH groups being 1.2. The flask contents are allowed to react in the presence of 500 ppm of titanium tetraisopropoxide for 10 hours at 230° C. under normal pressure and subsequent 5 hours under reduced pressures of from 10 to 15 mmHg. After adding 30 parts of trimellitic anhydride to the flask, the flask contents are allowed to react for 1 hour at 180° C. under normal pressure. Thus, a linear polyester resin is prepared. The resin has an acid value (AV) of 17.5 mgKOH/g, a Tg of 54.1° C., and an Mw of 12,700.

### Resin Synthesis Example 17

The procedure in Resin Synthesis Example 7 is repeated. Thereafter, 30 parts of trimellitic anhydride is added to the flask and the flask contents are allowed to react for 1 hour at 180° C. under normal pressure. Thus, a linear polyester resin is prepared. The resin has an acid value (AV) of 17.6 mgKOH/g, a Tg of 61.3° C., and an Mw of 14,500.

### Resin Synthesis Example 18

A 5-liter four-neck flask equipped with a nitrogen inlet pipe, a dewatering pipe, a stirrer, and a thermocouple is charged with a mixture of ethylene oxide 2 mol adduct of bisphenol A with propylene oxide 3 mol adduct of bisphenol A at a molar ratio of 90/10 and dimethyl isophthalate as an acid component, with the ratio of OH groups to COOH groups being 1.25. The flask contents are allowed to react in the presence of 500 ppm of titanium tetraisopropoxide for 10 hours at 230° C. under normal pressure and subsequent 5 hours under reduced pressures of from 10 to 15 mmHg. After adding 30 parts of trimellitic anhydride to the flask, the flask contents are allowed to react for 1 hour at 180° C. under normal pressure. Thus, a linear polyester resin is prepared. The resin has an acid value (AV) of 18.2 mgKOH/g, a Tg of 59.5° C., and an Mw of 7,200.

### Resin Synthesis Example 19

The procedure in Resin Synthesis Example 9 is repeated. Thereafter, 30 parts of trimellitic anhydride is added to the flask and the flask contents are allowed to react for 1 hour at 180° C. under normal pressure. Thus, a linear polyester resin is prepared. The resin has an acid value (AV) of 18.4 mgKOH/g, a Tg of 60.3° C., and an Mw of 12,300.

### Resin Synthesis Example 20

A 5-liter four-neck flask equipped with a nitrogen inlet pipe, a dewatering pipe, a stirrer, and a thermocouple is charged with a mixture of propylene glycol with propylene oxide 3 mol adduct of bisphenol A at a molar ratio of 70/30 and dimethyl terephthalate as an acid component, with the ratio of OH groups to COOH groups being 1.2. The flask contents are allowed to react in the presence of 500 ppm of titanium tetraisopropoxide for 10 hours at 230° C. under normal pressure and subsequent 5 hours under reduced pressures of from 10 to 15 mmHg. After adding 30 parts of trimellitic anhydride to the flask, the flask contents are allowed to react for 1 hour at 180° C. under normal pressure. Thus, a linear polyester resin is prepared. The resin has an acid value (AV) of 18.0 mgKOH/g, a Tg of 68.3° C., and an Mw of 6,400.

### Resin Synthesis Example 21

A 5-liter four-neck flask equipped with a nitrogen inlet pipe, a dewatering pipe, a stirrer, and a thermocouple is charged with a mixture of ethylene oxide 2 mol adduct of bisphenol A with propylene oxide 3 mol adduct of bisphenol A at a molar ratio of 40/60 and a mixture of terephthalic acid with adipic acid at a molar ratio of 95/5, with the ratio of OH groups to COOH groups being 1.2. The flask contents are allowed to react in the presence of 500 ppm of titanium tetraisopropoxide for 10 hours at 230° C. under normal pressure and subsequent 5 hours under reduced pressures of from 10 to 15 mmHg. After adding 30 parts of trimellitic anhydride to the flask, the flask contents are allowed to react for 1 hour at 180° C. under normal pressure. Thus, a linear polyester resin is prepared. The resin has an acid value (AV) of 18.2 mgKOH/g, a Tg of 70.4° C., and an Mw of 8,700.

### Resin Synthesis Example 22

The procedure in Resin Synthesis Example 10 is repeated. Thereafter, 30 parts of trimellitic anhydride is added to the flask and the flask contents are allowed to react for 1 hour at 180° C. under normal pressure. Thus, a linear polyester resin is prepared. The resin has an acid value (AV) of 16.8 mgKOH/g, a Tg of 67.3° C., and an Mw of 8,500.

### Resin Synthesis Example 23

A 5-liter four-neck flask equipped with a nitrogen inlet pipe, a dewatering pipe, a stirrer, and a thermocouple is charged with 1,400 g (70% by weight) of the amorphous resin prepared in Resin Synthesis Example 1 and 600 g (30% by weight) of the crystalline resin prepared in Resin Synthesis Example 4 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.5, the reaction system is agitated until it becomes visually uniform. Further, tin 2-ethylhexanoate in an amount of 10 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 24

A 5-liter four-neck flask equipped with a nitrogen inlet pipe, a dewatering pipe, a stirrer, and a thermocouple is charged with 1,100 g of the amorphous resin prepared in Resin Synthesis Example 2 and 900 g of the crystalline resin prepared in Resin Synthesis Example 5 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.6, the reaction system is agitated until it becomes visually uniform. Further, tin 2-ethylhexanoate in an amount of 10 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 25

A 5-liter four-neck flask equipped with a nitrogen inlet pipe, a dewatering pipe, a stirrer, and a thermocouple is charged with 800 g of the amorphous resin prepared in Resin Synthesis Example 3 and 1,200 g of the crystalline resin prepared in Resin Synthesis Example 6 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.7, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 26

A 5-liter four-neck flask equipped with a nitrogen inlet pipe, a dewatering pipe, a stirrer, and a thermocouple is charged with 800 g of the amorphous resin prepared in Resin Synthesis Example 2 and 1,200 g of the crystalline resin prepared in Resin Synthesis Example 5 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.7, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 27

A 5-liter four-neck flask equipped with a nitrogen inlet pipe, a dewatering pipe, a stirrer, and a thermocouple is charged with 1,400 g of the amorphous resin prepared in Resin Synthesis Example 3 and 600 g of the crystalline resin prepared in Resin Synthesis Example 6 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.5, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 28

A 5-liter four-neck flask equipped with a nitrogen inlet pipe, a dewatering pipe, a stirrer, and a thermocouple is charged with 1,100 g of the amorphous resin prepared in Resin Synthesis Example 1 and 900 g of the crystalline resin prepared in Resin Synthesis Example 4 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.6, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 29

A 5-liter four-neck flask equipped with a nitrogen inlet pipe, a dewatering pipe, a stirrer, and a thermocouple is charged with 1,100 g of the amorphous resin prepared in Resin Synthesis Example 1 and 900 g of the crystalline resin prepared in Resin Synthesis Example 6 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.7, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 30

A 5-liter four-neck flask equipped with a nitrogen inlet pipe, a dewatering pipe, a stirrer, and a thermocouple is charged with 800 g of the amorphous resin prepared in Resin Synthesis Example 2 and 1,200 g of the crystalline resin prepared in Resin Synthesis Example 4 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.5, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 31

A 5-liter four-neck flask equipped with a nitrogen inlet pipe, a dewatering pipe, a stirrer, and a thermocouple is charged with 1,400 g of the amorphous resin prepared in Resin Synthesis Example 3 and 600 g of the crystalline resin prepared in Resin Synthesis Example 5 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.6, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 32

A 5-liter four-neck flask equipped with a nitrogen inlet pipe, a dewatering pipe, a stirrer, and a thermocouple is charged with 1,100 g of the amorphous resin prepared in Resin Synthesis Example 3 and 900 g of the crystalline resin prepared in Resin Synthesis Example 5 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.5, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 33

A 5-liter four-neck flask equipped with a nitrogen inlet pipe, a dewatering pipe, a stirrer, and a thermocouple is charged with 800 g of the amorphous resin prepared in Resin Synthesis Example 1 and 1,200 g of the crystalline resin prepared in Resin Synthesis Example 6 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.6, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 34

A 5-liter four-neck flask equipped with a nitrogen inlet pipe, a dewatering pipe, a stirrer, and a thermocouple is charged with 1,400 g of the amorphous resin prepared in Resin Synthesis Example 2 and 600 g of the crystalline resin prepared in Resin Synthesis Example 4 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.7, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 35

A 5-liter four-neck flask equipped with a nitrogen inlet pipe, a dewatering pipe, a stirrer, and a thermocouple is charged with 800 g of the amorphous resin prepared in Resin Synthesis Example 3 and 1,200 g of the crystalline resin prepared in Resin Synthesis Example 4 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.6, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 36

A 5-liter four-neck flask equipped with a nitrogen inlet pipe, a dewatering pipe, a stirrer, and a thermocouple is charged with 1,400 g of the amorphous resin prepared in Resin Synthesis Example 1 and 600 g of the crystalline resin prepared in Resin Synthesis Example 5 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.7, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 37

A 5-liter four-neck flask equipped with a nitrogen inlet pipe, a dewatering pipe, a stirrer, and a thermocouple is charged with 1,100 g of the amorphous resin prepared in Resin Synthesis Example 2 and 900 g of the crystalline resin prepared in Resin Synthesis Example 6 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.5, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 38

A 5-liter four-neck flask equipped with a nitrogen inlet pipe, a dewatering pipe, a stirrer, and a thermocouple is charged with 1,400 g of the amorphous resin prepared in Resin Synthesis Example 2 and 600 g of the crystalline resin prepared in Resin Synthesis Example 6 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.6, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 39

A 5-liter four-neck flask equipped with a nitrogen inlet pipe, a dewatering pipe, a stirrer, and a thermocouple is charged with 1,100 g of the amorphous resin prepared in Resin Synthesis Example 3 and 900 g of the crystalline resin prepared in Resin Synthesis Example 4 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.7, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

### Resin Synthesis Example 40

A 5-liter four-neck flask equipped with a nitrogen inlet pipe, a dewatering pipe, a stirrer, and a thermocouple is charged with 800 g of the amorphous resin prepared in Resin Synthesis Example 1 and 1,200 g of the crystalline resin prepared in Resin Synthesis Example 5 and is subjected to reduced-pressure drying at 10 mmHg and 60° C. for 2 hours. After releasing nitrogen pressure, 2,000 g of ethyl acetate having been dewatered with molecular sieves 4 A is added to the flask under nitrogen gas flow to uniformly dissolve the resins. After adding 4,4′-diphenylmethane diisocyanate in an amount such that the ratio NCO/OH becomes 0.5, the reaction system is agitated until it becomes visually uniform. Further, tin 2-ethylhexanoate in an amount of 100 ppm is added as a catalyst. The reaction system is heated to 80° C. and subjected to reaction for 5 hours under reflux, obtaining a block copolymer solution. A part of the solution is taken out and dried up to isolate the resin. The resin is subjected to various evaluations of physical properties. The results are shown in Table 1.

TABLE 1

| | | | | | | Copolymer Resin (A) | | | |
|---|---|---|---|---|---|---|---|---|---|
| | Amorphous Resin (B) | | | | A + B | | Amorphous Polyester Resin (A2) | | |
| | | Composition | | | B/(A + B) | Composition | Composition | | |
| | Acid Value | (Synthesis No.) | Tg (° C.) | Mw | (%) | (Synthesis No.) | (Synthesis No.) | Tg (° C.) | Mw |
| Example 1 | 0.98 | 7 | 55.1 | 13,000 | 30 | 23 | 1 | 51.2 | 7,500 |
| Example 2 | 0.34 | 8 | 56.0 | 8,600 | 50 | 24 | 2 | 59.2 | 7,400 |
| Example 3 | 0.48 | 9 | 56.2 | 11,000 | 70 | 25 | 3 | 69.7 | 7,800 |
| Example 4 | 0.70 | 2 | 59.2 | 7,400 | 30 | 26 | 2 | 59.2 | 7,400 |
| Example 5 | 0.65 | 10 | 60.7 | 7,200 | 50 | 27 | 3 | 69.7 | 7,800 |
| Example 6 | 0.53 | 11 | 61.0 | 7,300 | 70 | 28 | 1 | 51.2 | 7,500 |
| Example 7 | 0.76 | 3 | 69.7 | 7,800 | 50 | 29 | 1 | 51.2 | 7,500 |
| Example 8 | 0.81 | 12 | 68.5 | 8,700 | 70 | 30 | 2 | 59.2 | 7,400 |
| Example 9 | 0.81 | 13 | 68.2 | 9,000 | 30 | 31 | 3 | 69.7 | 7,800 |
| Example 10 | 19.1 | 14 | 55.4 | 6,000 | 70 | 32 | 3 | 69.7 | 7,800 |
| Example 11 | 18.2 | 15 | 52.8 | 5,400 | 30 | 33 | 1 | 51.2 | 7,500 |
| Example 12 | 17.5 | 16 | 54.1 | 12,700 | 50 | 34 | 2 | 59.2 | 7,400 |
| Example 13 | 17.6 | 17 | 61.3 | 14,500 | 50 | 35 | 3 | 69.7 | 7,800 |
| Example 14 | 18.2 | 18 | 59.5 | 7,200 | 70 | 36 | 1 | 51.2 | 7,500 |
| Example 15 | 18.4 | 19 | 60.3 | 12,300 | 30 | 37 | 2 | 59.2 | 7,400 |
| Example 16 | 18.0 | 20 | 68.3 | 6,400 | 70 | 38 | 2 | 59.2 | 7,400 |
| Example 17 | 18.2 | 21 | 70.4 | 8,700 | 30 | 39 | 3 | 69.7 | 7,800 |
| Example 18 | 16.8 | 22 | 67.3 | 8,500 | 50 | 40 | 1 | 51.2 | 7,500 |
| Comparative | 18.4 | 19 | 60.3 | 12,300 | 50 | 37 | 2 | 59.2 | 7,400 |
| Example 1 | | | | | | | | | |

| | Copolymer Resin (A) | | | | | |
|---|---|---|---|---|---|---|
| | Crystalline Polyester Resin (A1) | | | | | |
| | Composition | | | A1/(A1 + A2) | | |
| | (Synthesis No.) | Tm (° C.) | Mw | (%) | NCO (%) | Melting Point (° C.) |
| Example 1 | 4 | 56.3 | 21,000 | 30 | 0.5 | 51.2 |
| Example 2 | 5 | 62.3 | 24,000 | 45 | 0.6 | 60.4 |
| Example 3 | 6 | 64.5 | 18,500 | 60 | 0.7 | 65.1 |
| Example 4 | 5 | 62.3 | 24,000 | 60 | 0.7 | 61.0 |
| Example 5 | 6 | 64.5 | 18,500 | 30 | 0.5 | 66.6 |
| Example 6 | 4 | 56.3 | 21,000 | 45 | 0.6 | 53.7 |
| Example 7 | 6 | 64.5 | 18,500 | 45 | 0.7 | 65.8 |
| Example 8 | 4 | 56.3 | 21,000 | 60 | 0.5 | 52.7 |
| Example 9 | 5 | 62.3 | 24,000 | 30 | 0.6 | 58.9 |
| Example 10 | 5 | 62.3 | 24,000 | 45 | 0.5 | 58.4 |
| Example 11 | 6 | 64.5 | 18,500 | 60 | 0.6 | 65.6 |
| Example 12 | 4 | 56.3 | 21,000 | 30 | 0.7 | 52.8 |
| Example 13 | 4 | 56.3 | 21,000 | 60 | 0.6 | 53.0 |
| Example 14 | 5 | 62.3 | 24,000 | 30 | 0.7 | 57.4 |
| Example 15 | 6 | 64.5 | 18,500 | 45 | 0.5 | 64.5 |
| Example 16 | 6 | 64.5 | 18,500 | 30 | 0.6 | 66.1 |
| Example 17 | 4 | 56.3 | 21,000 | 45 | 0.7 | 52.4 |
| Example 18 | 5 | 62.3 | 24,000 | 60 | 0.5 | 59.3 |
| Comparative | 6 | 64.5 | 18,500 | 75 | 0.6 | 63.8 |
| Example 1 | | | | | | |

### Example 1

First, 70 parts of the copolymer resin (A) prepared in Resin Synthesis Example 23, 30 parts of the amorphous resin (B) prepared in Resin Synthesis Example 7, 6 parts of a paraffin wax (i.e., a hydrocarbon wax HNP-9 from Nippon Seiro Co., Ltd. having a melting point of 75° C. and a solubility parameter of 8.8), and 6 parts of a carbon black (i.e., Printex 35 from Degussa having a DBP oil absorption amount of 42 mL/100 mg and a pH of 9.5) are added to ethyl acetate in an amount such that the solid content concentration becomes 52%. In an autoclave, the mixture is heated to 80° C., kept for 5 hours, and cooled to 30° C. over a period of 1 hour, while being agitated. The resulting liquid is subjected to a dispersion treatment using a bead mill (ULTRAVISCOMILL from Aimex Co., Ltd.) filled with 80% by volume of zirconia beads having a diameter of 0.5 mm, at a liquid feeding speed of 1 kg/hour and a disc peripheral speed of 6 m/sec. This dispersing operation is repeated 3 times (3 passes) to obtain an oily phase liquid.

Next, 40 parts of the oily phase liquid is mixed with 60 parts of an aqueous phase using a TK HOMOMIXER (from PRIMIX Corporation) for 2 minutes at a revolution of 13,000 rpm and subsequent 10 minutes at a revolution of 250 rpm under gentle agitation. Thus, an emulsion slurry is obtained.

The aqueous phase is prepared by mixing 0.5 parts of sodium chloride (from Tokyo Chemical Industry Co., Ltd.) and 7 parts of ethyl acetate in 100 parts of a 0.5% aqueous solution of sodium dodecyl sulfate (from Tokyo Chemical Industry Co., Ltd.). The aqueous phase is a milky whitish liquid.

The emulsion slurry is contained in a vessel equipped with a stirrer and a thermometer and subjected to solvent removal for 8 hours at 30° C. and subsequent aging for 4 hours at 45° C. Thus, a dispersion slurry is obtained.

After the dispersion slurry is filtered under reduced pressures, (1) the resulting wet cake is mixed with 100 parts of ion-exchange water using a TK HOMOMIXER for 10 minutes at a revolution of 12,000 rpm, followed by filtering, thus obtaining a wet cake (i).

(2) The wet cake (i) is mixed with 100 parts of 10% aqueous solution of sodium hydroxide using a TK HOMOMIXER for 30 minutes at a revolution of 12,000 rpm, followed by filtering under reduced pressures, thus obtaining a wet cake (ii).

(3) The wet cake (ii) is mixed with 100 parts of 10% hydrochloric acid using a TK HOMOMIXER for 10 minutes at a revolution of 12,000 rpm, followed by filtering, thus obtaining a wet cake (iii).

(4) The wet cake (iii) is mixed with 300 parts of ion-exchange water using a TK HOMOMIXER for 10 minutes at a revolution of 12,000 rpm, followed by filtering. These operations (1) to (4) are repeated twice, thus obtaining a wet cake (iv).

The wet cake (iv) is dried by a circulating air dryer for 48 hours at 45° C. and then filtered with a mesh having openings of 75 μm. Thus, a toner 1 is prepared.

### Example 2

The procedure in Example 1 is repeated except for replacing the copolymer resin (A) with that prepared in Resin Synthesis Example 24 and the amorphous resin (B) with that prepared in Resin Synthesis Example 8 and changing the ratio therebetween to 50/50.

### Example 3

The procedure in Example 1 is repeated except for replacing the copolymer resin (A) with that prepared in Resin Synthesis Example 25 and the amorphous resin (B) with that prepared in Resin Synthesis Example 9 and changing the ratio therebetween to 30/70.

### Example 4

The procedure in Example 1 is repeated except for replacing the copolymer resin (A) with that prepared in Resin Synthesis Example 26 and the amorphous resin (B) with that prepared in Resin Synthesis Example 2 and changing the ratio therebetween to 70/30.

### Example 5

The procedure in Example 1 is repeated except for replacing the copolymer resin (A) with that prepared in Resin Synthesis Example 27 and the amorphous resin (B) with that prepared in Resin Synthesis Example 10 and changing the ratio therebetween to 50/50.

### Example 6

The procedure in Example 1 is repeated except for replacing the copolymer resin (A) with that prepared in Resin Synthesis Example 28 and the amorphous resin (B) with that prepared in Resin Synthesis Example 11 and changing the ratio therebetween to 30/70.

### Example 7

The procedure in Example 1 is repeated except for replacing the copolymer resin (A) with that prepared in Resin Synthesis Example 29 and the amorphous resin (B) with that prepared in Resin Synthesis Example 3 and changing the ratio therebetween to 50/50.

### Example 8

The procedure in Example 1 is repeated except for replacing the copolymer resin (A) with that prepared in Resin Synthesis Example 30 and the amorphous resin (B) with that prepared in Resin Synthesis Example 12 and changing the ratio therebetween to 30/70.

### Example 9

The procedure in Example 1 is repeated except for replacing the copolymer resin (A) with that prepared in Resin Synthesis Example 31 and the amorphous resin (B) with that prepared in Resin Synthesis Example 13 and changing the ratio therebetween to 70/30.

### Example 10

The procedure in Example 1 is repeated except for replacing the copolymer resin (A) with that prepared in Resin Synthesis Example 32 and the amorphous resin (B) with that prepared in Resin Synthesis Example 14 and changing the ratio therebetween to 30/70.

### Example 11

The procedure in Example 1 is repeated except for replacing the copolymer resin (A) with that prepared in Resin Synthesis Example 33 and the amorphous resin (B) with that prepared in Resin Synthesis Example 15 and changing the ratio therebetween to 70/30.

### Example 12

The procedure in Example 1 is repeated except for replacing the copolymer resin (A) with that prepared in Resin Synthesis Example 34 and the amorphous resin (B) with that prepared in Resin Synthesis Example 16 and changing the ratio therebetween to 50/50.

### Example 13

The procedure in Example 1 is repeated except for replacing the copolymer resin (A) with that prepared in Resin Synthesis Example 35 and the amorphous resin (B) with that prepared in Resin Synthesis Example 17 and changing the ratio therebetween to 50/50.

### Example 14

The procedure in Example 1 is repeated except for replacing the copolymer resin (A) with that prepared in Resin Synthesis Example 36 and the amorphous resin (B) with that prepared in Resin Synthesis Example 18 and changing the ratio therebetween to 30/70.

### Example 15

The procedure in Example 1 is repeated except for replacing the copolymer resin (A) with that prepared in Resin Synthesis Example 37 and the amorphous resin (B) with that prepared in Resin Synthesis Example 19 and changing the ratio therebetween to 70/30.

### Example 16

The procedure in Example 1 is repeated except for replacing the copolymer resin (A) with that prepared in Resin Synthesis Example 38 and the amorphous resin (B) with that prepared in Resin Synthesis Example 20 and changing the ratio therebetween to 30/70.

### Example 17

The procedure in Example 1 is repeated except for replacing the copolymer resin (A) with that prepared in Resin Synthesis Example 39 and the amorphous resin (B) with that prepared in Resin Synthesis Example 21 and changing the ratio therebetween to 70/30.

### Example 18

The procedure in Example 1 is repeated except for replacing the copolymer resin (A) with that prepared in Resin Synthesis Example 40 and the amorphous resin (B) with that prepared in Resin Synthesis Example 22 and changing the ratio therebetween to 50/50.

### Comparative Example 1

The procedure in Example 15 is repeated except for changing the amount of the crystalline resin in the copolymer resin (A) to 75% by weight. In the resulting toner, the domains of the first phase-contrast images are streaky and the maximum Feret diameter of each domain account for 300 nm or more. The minimum Feret diameter is 137 nm. In this toner, mobility of the crystalline resin cannot be restrained, resulting in poor print durability.

### Evaluations

### Fixability (Minimum Fixable Temperature)

Each of the above-prepared toners is set in the tandem-type full-color image forming apparatus 100C illustrated in FIG. 7. A solid image with a toner deposition amount of 0.85±0.10 mg/cm² and an image area of 3 cm×8 cm is formed on sheets of a transfer paper (printing paper <70> from Ricoh Japan Co., Ltd.) and fixed on each sheet at various fixing belt temperatures. The fixed image is subjected to a scratch drawing test with a drawing tester AD-401 (from Ueshima Seisakusho Co., Ltd.) equipped with a ruby needle (having a point radius of from 260 to 320 μmR and a point angle of 60 degrees) at a load of 50 g. The image surface is then strongly rubbed with a fabric (HONECOTTO #440 from SAKATA INX ENG. CO., LTD) for 5 times. The temperature of the fixing belt at which almost no peeling-off of the image occurred is determined as the minimum fixable temperature. The solid image is formed on the sheet 3.0 cm away from the leading edge in the paper feeding direction. The speed at which the sheet passes through the nip portion of the fixing device is 280 mm/s. The lower the minimum fixable temperature, the better the low-temperature fixability.

### Evaluation Criteria

A: not greater than 105° C.

B: greater than 105° C. and not greater than 115° C.

C: greater than 115° C. and not greater than 130° C.

D: greater than 130° C.

### Abrasion Resistance in Paper Ejection

A developer including each of the above-prepared toners is set in an image forming apparatus IMAGIO C2802. A solid image having a toner deposition amount of 0.6 mg/cm² is continuously formed on 10 sheets of A4 paper. The printed images are visually observed to determine the following ranks.

Namely, the fixed images are visually observed to confirm whether high-gloss and low-gloss portions are present or not and whether scratch or peeling-off is caused or not, by contact with conveyance members.

### Evaluation Criteria

A: Whether the image has contacted the conveyance members or not cannot be confirmed by visual observation

B: A slight gloss difference is observed between the portions of contact and non-contact with the conveyance members. Depending on the way of lightening, a mark of contact can be visually observed.

C: A slight gloss difference is observed between the portions of contact and non-contact with the conveyance members. Depending on the way of lightening, a mark of contact can be visually observed. Streaky scratch is observed.

D: A gloss difference is observed between the portions of contact and non-contact with the conveyance members. A mark of contact can be visually observed. Streaky scratch is observed. Peeling-off of toner caused to expose the paper surface.

The evaluation results are shown in Table 2.

TABLE 2

| | Properties | | | | |
|---|---|---|---|---|---|
| | | | | | Abrasion |
| | | | | | Resistance |
| | Average | | | | in |
| | Diameter | t130 | t′70 | | Paper |
| | (nm) | (msec) | (msec) | Fixability | Ejection |
| Example 1 | 56 | 16.8 | 0.6 | B | C |
| Example 2 | 53 | 15.3 | 0.35 | B | A |
| Example 3 | 44 | 15.6 | 0.42 | B | A |
| Example 4 | 87 | 36 | 0.71 | A | C |
| Example 5 | 43 | 12.9 | 0.28 | C | A |
| Example 6 | 32 | 14.5 | 0.4 | B | C |
| Example 7 | 48 | 14.2 | 0.31 | C | A |
| Example 8 | 35 | 13.1 | 0.48 | C | B |
| Example 9 | 70 | 12.5 | 0.25 | C | A |
| Example 10 | 25 | 15.8 | 0.38 | B | B |
| Example 11 | 95 | 32 | 0.79 | A | C |
| Example 12 | 37 | 13.8 | 0.52 | B | B |
| Example 13 | 58 | 24.3 | 0.42 | B | B |
| Example 14 | 23 | 12.7 | 0.28 | C | A |
| Example 15 | 78 | 21.2 | 0.45 | B | B |
| Example 16 | 17 | 12.2 | 0.12 | C | A |
| Example 17 | 73 | 23.5 | 0.24 | B | A |
| Example 18 | 74 | 23.7 | 0.58 | B | B |
| Comparative | 137 | 26.1 | 0.9 | B | D |
| Example 1 | | | | | |

The evaluation results for Examples 1-18 and Comparative Example 1 indicate that the toners according to some embodiments of the present invention achieve an excellent balance between low-temperature fixability and heat-resistant storage stability; avoid the problems specific to toner including crystalline resin, such as toner aggregation in developing device or toner contamination of carrier particles or the inside of apparatus caused by poor mechanical durability of the toner, and deterioration in chargeability and fluidity caused by embedment of external additives to the surface of the toner; and provide high-quality image with high rub resistance by rapidly recovering its elastic modulus after being fixed on recording medium to improve the hardness of the fixed image.

What is claimed is:

1. A toner, comprising:
a colorant;
a release agent; and
a binder resin, the binder resin including:
a copolymer resin (A) having a structural unit derived from a crystalline polyester resin (A1) and another structural unit derived from an amorphous polyester resin (A2); and
an amorphous resin (B) in an amount of from 30 to 70% by weight based on total weight of the binder resin,
wherein when the binder resin is observed with an atomic force microscope in tapping mode to obtain a phase image and the phase image is binarized by using an intermediate value between maximum and minimum phase difference values to obtain a binarized image, the binarized image consists of first phase-contrast images serving as large-phase-difference portions and second phase-contrast images serving as small-phase-difference portions with the first phase-contrast images dispersed in the second phase-contrast images forming a dot-like or streaky structure, and
wherein an average value of dispersion diameters, corresponding to maximum Feret diameters, of the first phase-contrast images in the dot-like structure, or widths, corresponding to minimum Feret diameters, of the first phase-contrast images in the streaky structure, is less than 100 nm when determined by the following procedures (I) to (III):
(I) subject ten randomly-selected 300-nm-square phase images of the binder resin to the binarization processing;
(II) measure the maximum Feret diameters of the first phase-contrast images in the dot-like structure or the minimum Feret diameters of the first phase-contrast images in the streaky structure in each of the ten binarized images; and
(III) average the top 30 maximum Feret diameters of the first phase-contrast images in the dot-like structure or the top 30 minimum Feret diameters of the first phase-contrast images in the streaky structure.

2. The toner according to claim 1, wherein a spin-spin relaxation time (t130) at 130° C. is 12 ms or more when the toner is heated to 130° C. and a spin-spin relaxation time (t′70) at 70° C. is 0.8 ms or less when the toner is cooled from 130° C. to 70° C. when measured by pulsed NMR.

3. The toner according to claim 1, wherein the copolymer resin (A) has a melting point of from 50 to 65° C.

4. The toner according to claim 1, wherein the amorphous resin (B) has a glass transition temperature of from 50 to 70° C.

5. The toner according to claim 1, wherein the toner is prepared by a method including:
dispersing an oily phase including the colorant, the release agent, the copolymer resin (A), and the amorphous resin (B), in an aqueous medium.

6. The toner according to claim 1, wherein the binder resin further comprises a crystalline resin (C).

7. A developer, comprising
the toner according to claim 1; and
a carrier.

8. An image forming apparatus, comprising:
an electrostatic latent image bearing member;
an electrostatic latent image forming device to form an electrostatic latent image on the electrostatic latent image bearing member;
a developing device to develop the electrostatic latent image into a visible image with the toner according to claim 1;
a transfer device to transfer the visible image onto a recording medium; and
a fixing device to fix the visible image on the recording medium.
